(19) United States
(12) Patent Application Publication
(10) Pub. No.: US 2013/0153829 A1
(43) Pub. Date: Jun. 20, 2013

(54) COATING FORMING COMPOSITION USED FOR FORMING TRANSPARENT CONDUCTIVE FILM

(71) Applicant: JNC CORPORATION, Tokyo (JP)

(72) Inventors: YASUHIRO KONDO, CHIBA (JP); MOTOKI YANAI, CHIBA (JP); SETSUO ITAMI, CHIBA (JP)

(73) Assignee: JNC CORPORATION, TOKYO (JP)

(21) Appl. No.: 13/707,566

(22) Filed: Dec. 6, 2012

(30) Foreign Application Priority Data
Dec. 15, 2011 (JP) 2011-274515

(51) Int. Cl. H01B 1/02

(52) U.S. Cl. CPC H01B 1/02; Y10S 977/762; B82Y 30/00
USPC 252/503; 977/762

(57) ABSTRACT

A subject is to provide a material capable of obtaining a transparent conductive film that is excellent in conductivity, optical transmission, environmental reliability, suitability for process and adhesion in a single application process, and to provide the transparent conductive film and a device element using the same; a solution is to prepare a coating forming composition containing at least one kind selected from the group of metal nanowires and metal nanotubes as a first component, polysaccharides and a derivative thereof as a second component, an active methylene compound as a third component, an electrophilic compound as a fourth component and a solvent as a fifth component to obtain the transparent conductive film by using the coating.

### CROSS-REFERENCE TO RELATED APPLICATION

This application claims the priority benefit of Japan application serial no. 2011-274515, filed on Dec. 15, 2011. The entirety of the above-mentioned patent application is hereby incorporated by reference herein and made a part of this specification.

### BACKGROUND OF THE INVENTION

1. Technical Field

The present invention relates to a coating forming composition. More specifically, the invention relates to a method for manufacturing a substrate having a transparent conductive film that is excellent in conductivity, optical transmission, environmental reliability and suitability for process, and a device element using the substrate.

2. Background Art

A transparent conductive film is used for a transparent electrode for a liquid crystal display (LCD), a plasma display panel (PDP), an organic electroluminescence display, a photovoltaic (PV) cell and a touch panel (TP). The transparent conductive film is further used in various fields such as an electrostatic discharge (ESD) film and an electromagnetic interference (EMI) film. For the applications described above, (1) a low surface resistance, (2) a high optical transmittance and (3) a high reliability are required.

Indium tin oxide (ITO) has been so far applied to the transparent conductive film used for the transparent electrodes.

However, indium used for ITO has a problem of supply anxiety and price soaring. Moreover, a sputtering method needing a high vacuum is used for forming an ITO layer. Therefore, a scale of manufacturing equipment becomes large, resulting in a long manufacturing time and a high cost. Furthermore, the ITO layer easily breaks by generating a crack due to a physical stress such as bending. Because a high amount of heat is generated in sputtering on the ITO layer sputtering, a polymer on a flexible substrate is damaged. Thus, application of the sputtering method to a substrate provided with flexibility is difficult. Therefore, an ITO substitute material in which the problems are solved has been actively searched.

Consequently, as a material allowing application and film formation without needing sputtering among kinds of “ITO substitute material,” specific examples of materials have been reported, including (i) a polymer conductive material such as poly(3,4-ethylenedioxythiophene)-poly(4-styrenesulfonate) (PEDOT:PSS) (see Patent literature No. 1), (ii) a conductive material containing metal nanowires (see Patent literature No. 2 and Non-patent literature No. 1), (iii) a conductive material including a random network structure by fine silver particles (see Patent literature No. 3), (iv) a conductive material containing a conductive component having nanostructure, such as a conductive material containing carbon nanotubes (see Patent literature No. 4) and (v) a conductive material including a fine mesh using metal fine wiring (see Patent literature No. 5).

However, the material disclosed in (i) has a disadvantage of a low optical transmittance and a poor environmental reliability because the conductive material includes organic molecules, the material disclosed in (iii) has a disadvantage of a complex process because the transparent conductive film is prepared using self-organization, the material disclosed in (iv) has a disadvantage of a blackish color and a reduced optical transmittance due to the carbon nanotubes, and the material disclosed in (v) has a disadvantage of impossibility of utilizing the process that has been applied so far because a photographic technology is used.

Among the materials allowing application and film formation, the conductive material containing the metal nanowires disclosed in (ii) is optimum for “ITO substitute material” because the conductive material is reported to show a low surface resistance and a high optical transmittance (see Patent literature No. 2 and Non-patent literature No. 1, for example), and has also flexibility.

As a solvent of a composition for the conductive material containing the metal nanowires disclosed in Patent literature No. 2 and Non-patent literature No. 1, an organic solvent having a large hydrophobicity such as toluene and hexane has been rarely used so far. The reason is that the metal nanowires have a hydrophilic compound caused from a manufacturing process on a surface thereof, and therefore have only a poor affinity with the organic solvent having a large hydrophobicity and aggregate.

If the hydrophilic compound on a metal surface is replaced by a hydrophobic compound, the metal nanowires can be used also in a hydrophobic organic solvent. For example, metal fine particles can be dispersed into the hydrophobic organic solvent by modifying the metal surface with long-chain alkanethiol. However, if a metal nanowire surface is modified with long-chain alkanethiol, no development of conductivity is easily presumed because self-assembled monolayer of long-chain alkanethiol on surface of metal nanowire interferes with connecting the metal nanowires with each other.

On the other hand, when an aqueous composition is used, such characteristics are not obtained as dispersibility, suitability for process and environmental reliability that are easily obtained using an organic solvent-based composition. The reason is that water is a peculiar liquid having characteristics not seen in the organic solvent, such as having a large polarity, hydrogen-bonding capability and active hydrogen, and dissolving an ionic salt, and thus an organic compound that can be used in an aqueous solution is limited in view of stability in the aqueous solution, solubility in the aqueous solution, or the like.

Such a poor process resistance of the metal nanowires becomes a problem in a general manufacturing process that has been applied so far.

For example, the transparent conductive film needs patterning according to an application. In general, a photolithography using a resist material is utilized for patterning. The photolithography includes processes of resist application, bake, exposure, development, etching and strip, and actually includes suitable substrate surface treatment, cleaning and drying processes before and after each process. In particular, the cleaning process is essential to an application to an electronic material or the like for preventing a particulate impurity, dirt and dust from depositing or entraining onto a substrate surface.

A metal nanowire coating formed using the aqueous composition is prepared using a compound easily dissolvable in water. Therefore, dissolution, peeling and so forth of the film occur particularly in a process using the aqueous solution, namely, the development, etching, strip and cleaning processes. Furthermore, deterioration of characteristics of the coating occurs under a high temperature and a high humidity, and thus the coating has no sufficient suitability for process and environmental reliability.

The film forming composition as described in Patent literature No. 2 is considered to have a poor process resistance because of no use of a crosslinkable compound. Moreover, the transparent conductive films as described in Patent literatures No. 6 and No. 7 are prepared by forming a transparent conductive film using silver nanowires in a first layer, forming a film of an organic conductive material in a second layer, and further adding a crosslinkable compound to either one of the layers. The film formed by the method is considered to have a low environmental reliability because the film is constituted of an organic conductive material. Moreover, the number of processes increases because formation of two layers is essential.

Accordingly, an ITO substitute transparent conductive film that is excellent in (1) conductivity, (2) optical transmission, (3) environmental reliability and (4) process resistance, and for which the general process that has been applied so far can be used is required.

### REFERENCES LIST

### Patent Literature

Patent literature No. 1: JP 2004-59666 A.
Patent literature No. 2: JP 2009-505358 A.
Patent literature No. 3: JP 2008-78441 A.
Patent literature No. 4: JP 2007-112133 A.
Patent literature No. 5: JP 2007-270353 A.
Patent literature No. 6: JP 2010-244747 A.
Patent literature No. 7: JP 2010-205532 A.

### Non-Patent Literature

Non-patent literature No. 1: Shih-Hsiang Lai, Chun-Yao Ou, “SID 08 DIGEST,” 2008, pp. 1200-1202.

### SUMMARY OF THE INVENTION

### Technical Problem

An aim of the invention is to prepare a coating forming composition that is excellent in dispersion and storage stability of a conductive component in a solution, and to form a coating that is excellent in conductivity, optical transmission, environmental reliability, process resistance and adhesion in a single application process using the composition.

### Solution to Problem

The present inventors have diligently continued to conduct research for a component of a composition for forming a transparent conductive film, as a result, have found that a coating forming composition containing metal nanowires and metal nanotubes, polysaccharides and a derivative thereof, an active methylene compound, an electrophilic compound and a solvent allows a good dispersion of the metal nanowires or the metal nanotubes, and the composition can form a transparent conductive film that is excellent in conductivity, optical transmittance, environmental reliability, suitability for process and adhesion through a crosslinking reaction between the active methylene compounds during bake in a general single application process that has been applied so far.

The invention concerns a coating forming composition, containing at least one kind selected from the group of metal nanowires and metal nanotubes as a first component, at least one kind selected from the group of polysaccharides and a derivative thereof as a second component, an active methylene compound as a third component, an electrophilic compound as a fourth component, and a solvent as a fifth component.

The invention also concerns a substrate having a transparent conductive film obtained using the coating forming composition as described above, wherein a thickness of a transparent conductive film is in the range of 10 nanometers to 150 nanometers, a surface resistance of the transparent conductive film is in the range of 10 ohms/square (hereinafter, occasionally expressed in terms of Ω/□ for ohms/square) to 5,000Ω/□, and a transmittance of the transparent conductive film is in the range of 85% or more.

The invention further concerns a device element, using the substrate as described above.

The invention is as described below, for example.

The present invention is directed to a coating forming composition. The coating forming composition contains at least one kind selected from the group of metal nanowires and metal nanotubes as a first component; at least one kind selected from the group of polysaccharides and a derivative thereof as a second component; an active methylene compound as a third component; an electrophilic compound as a fourth component; and a solvent as a fifth component.

According to an embodiment of the present invention, the electrophilic compound as the fourth component is at least one kind selected from the group of an isocyanate compound, an epoxy compound, an aldehyde compound, an amine compound and a methylol compound.

According to an embodiment of the present invention, the active methylene compound as the third component is a compound having a 1,3-dicarbonyl group.

According to an embodiment of the present invention, the first component is silver nanowires.

According to an embodiment of the present invention, wherein the second component is a cellulose ether derivative.

According to an embodiment of the present invention, the third component is polyvinyl alcohol having an acetoacetyl group.

According to an embodiment of the present invention, the electrophilic compound as the fourth component contains a methylol compound.

According to an embodiment of the present invention, the second component is hydroxypropyl methyl cellulose.

According to an embodiment of the present invention, a content of the first component is in the range of 0.01% by weight to 1.0% by weight, a content of the second component is in the range of 0.005% by weight to 3.0% by weight, a content of the third component is in the range of 0.0005% by weight to 3.0% by weight, a content of the fourth components is in the range of 0.000055% by weight to 6.0% by weight, and a content of the solvent is in the range of 87.0% by weight to 99.98% by weight, based on the total weight of the coating forming composition.

According to an embodiment of the present invention, the coating forming composition is used for forming a conductive coating.

The present invention is directed to a substrate having a transparent conductive film obtained using the coating forming composition, wherein a thickness of a transparent conductive film is in the range of 10 nanometers to 150 nanometers, a surface resistance of the transparent conductive film is in the range of 10Ω/□ to 5,000Ω/□, and a transmittance of the transparent conductive film is in the range of 85% or more.

The present invention is directed to a device element, using the substrate having a transparent conductive film obtained using the coating forming composition.

### Advantageous Effects of Invention

According to the invention, a composition in which metal nanowires or metal nanotubes are favorably dispersed is obtained. Moreover, a coating that is excellent in conductivity, optical transmission, environmental reliability, suitability for process and adhesion can be formed by applying the composition onto a substrate in manufacturing a transparent conductive film. Moreover, the thus obtained transparent conductive film can have both a low surface resistance value and good optical properties such as a good optical transmittance.

### DESCRIPTION OF THE EMBODIMENTS

Hereinafter, the invention will be specifically explained.

“Transparent conductive film” herein means a film having a surface resistance in the range of approximately 10⁴Ω/□ or less, and a total transmittance in the range of approximately 80% or more.

“Binder” is a resin used for allowing a conductive material of metal nanowires or metal nanotubes to disperse in a conductive film and to support the conductive material thereon.

### 1. Coating Forming Composition

A coating forming composition of the invention contains at least one kind selected from the group of metal nanowires and metal nanotubes (hereinafter, referred to as the metal nanowires and the metal nanotubes sometimes) as a first component, at least one kind selected from the group of polysaccharides and a derivative thereof (hereinafter referred to as the polysaccharides and the derivative thereof sometimes) as a second component, an active methylene compound as a third component, an electrophilic compound as a fourth component and a solvent as a fifth component.

### 1-1. First Component: Metal Nanowires and Metal Nanotubes

The coating forming composition of the invention contains at least one kind selected from the group of metal nanowires and metal nanotubes as the first component. The first component forms a network in a coating obtained from the composition of the invention and provides the coating with conductivity.

“Metal nanowires” herein means a conductive material having a wire shape, and the metal nanowires may be linear or gently or steeply bent. Properties may be flexible or rigid.

“Metal nanotubes” herein means a conductive material having a porous or nonporous tubular shape, and the metal nanotubes may be linear or gently or steeply bent. Properties may be flexible or rigid.

Either the metal nanowires or the metal nanotubes may be used, or both may be mixed and used.

Specific examples of kinds of metals include at least one kind selected from the group of gold, silver, platinum, copper, nickel, iron, cobalt, zinc, ruthenium, rhodium, palladium, cadmium, osmium and iridium, or an alloy obtained by combining the metals. From a viewpoint of obtaining a coating having a low surface resistance and a high total transmittance, at least one kind of any of gold, silver and copper is preferably contained. The metals have a high conductivity, and therefore density of the metal on a surface can be reduced upon obtaining a desired surface resistance, and thus a high transmittance can be realized. Above all, at least one kind of gold or silver is preferably contained. As an optimum embodiment, silver is preferred.

Length, in a minor axis, of the first component in the coating forming composition, length thereof in a major axis and an aspect ratio thereof have a fixed distribution. The distribution is selected from a viewpoint where the coating obtained from the composition of the invention becomes high in the total transmittance and low in the surface resistance. Specifically, a mean of the length of the first component in the minor axis is preferably in the range of approximately 1 nanometer to approximately 500 nanometers, further preferably, in the range of approximately 5 nanometers to approximately 200 nanometers, still further preferably, in the range of approximately 5 nanometers to approximately 100 nanometers, particularly preferably, in the range of approximately 10 nanometers to approximately 100 nanometers. Moreover, a mean of the length of the first component in the major axis is preferably in the range of approximately 1 micrometer to approximately 100 micrometers, further preferably, in the range of approximately 1 micrometer to approximately 50 micrometers, still further preferably, in the range of approximately 2 micrometers to approximately 50 micrometers, particularly preferably, in the range of approximately 5 micrometers to approximately 30 micrometers. As for the first component, the mean of the length thereof in the minor axis and the mean of the length thereof in the major axis satisfy the ranges as described above, and a mean of the aspect ratio is preferably larger than approximately 1, further preferably, approximately 10 or more, still further preferably, approximately 100 or more, particularly preferably, approximately 200 or more. Herein, “aspect ratio” is expressed in terms of a value determined from an equation: a/b, when an average length of the first component in the minor axis is approximated as “b,” and an average length of the first component in the major axis is approximated as “a.” Then, “a” and “b” can be measured using a scanning electron microscope. In the invention, scanning electron microscope SU-70 (made by Hitachi High-Technologies Corporation) has been used.

As a method for manufacturing the first component, a publicly known manufacturing method can be applied. For example, silver nanowires can be synthesized by reducing silver nitrate in the presence of polyvinylpyrrolidone by applying a polyol process (Chem. Mater., 2002, 14, 4736). Moreover, the silver nanowires can also be synthesized by reducing silver nitrate through nucleus formation and a double jet process without using polyvinyl pyrrolidone, as described in Patent literature No. 5.

A diameter of nanowires and a length thereof can be controlled by changing reaction conditions or types of reducing agents, or by adding a salt. The diameter of nanowires and the length thereof are controlled by changing reaction temperatures and reducing agents in WO 2008/073143 A. The diameter can also be controlled by addition of potassium bromide (ACS NANO, 2010, 4, 5, 2955).

Gold nanowires can also be synthesized by reducing chloroaurate hydrate in the presence of polyvinylpyrrolidone in a similar manner (J. Am. Chem. Soc., 2007, 129, 1733). A technology for synthesizing and purifying the silver nanowires and the gold nanowires in a large scale is described in detail in WO 2008/073143 A and WO 2008/046058 A.

Gold nanotubes having a porous structure can be synthesized by using the silver nanowires as a template and according to an electro-less displacement plating reaction with the silver nanowires per se by using a chlorauric acid solution. A surface of the silver nanowires is covered with gold according to the electro-less displacement plating reaction of silver with chloroauric acid, on the other hand, the silver nanowires used as the template are dissolved out into the solution, as a result, the gold nanotubes having the porous structure can be prepared (J. Am. Chem. Soc., 2004, 126, 3892-3901). Moreover, the silver nanowires as the template can also be removed by using an aqueous ammonia solution (ACS NANO, 2009, 3, 6, 1365-1372).

From a viewpoint of a high conductivity and transparency, content of the first component is preferably in the range of approximately 0.01% by weight to approximately 1.0% by weight, further preferably, in the range of approximately 0.05% by weight to approximately 0.75% by weight, still further preferably, in the range of approximately 0.1% by weight to approximately 0.5% by weight, based on the total weight of the coating forming composition.

### 1-2. Second Component: Polysaccharide and a Derivative Thereof

The coating forming composition of the invention contains at least one kind selected from the group of polysaccharides and a derivative thereof as the second component. The second component provides the first component with dispersibility in a water solvent by increasing a viscosity of the composition. The second component forms a film and simultaneously connects the resultant film with a substrate during film formation. Moreover, the second component plays a role of a binder. The second component is considered to exhibit functions such as a good dispersibility, a high conductivity and a high optical transmission without adversely affecting dispersibility of the first component in the composition, and without destroying a conductive network that the first component forms in the coating obtained from the composition.

Specific examples of the polysaccharides and the derivative thereof to be used for the composition of the invention include polysaccharides such as starch, gum arabic, hydroxypropyl methyl cellulose, carboxymethyl cellulose, hydroxyethyl cellulose, methyl hydroxyethyl cellulose, chitosan, dextran, guar gum and glucomannan, and a derivative thereof. The polysaccharides and the derivative thereof are preferably polysaccharides such as xanthan gum, hydroxypropyl methyl cellulose, carboxymethyl cellulose, hydroxyethyl cellulose, methyl hydroxyethyl cellulose, dextran, guar gum and glucomannan, and a derivative thereof, further preferably, a cellulose ether derivative such as hydroxypropyl methyl cellulose, methyl hydroxyethyl cellulose, carboxymethyl cellulose, methylcellulose and ethylcellulose, particularly preferably, hydroxypropyl methyl cellulose. Moreover, in the second component, a compound having a carbonyl group, a sulfonic acid group, a phosphonic acid group or the like may form a salt with sodium, potassium, calcium, ammonium, or the like. In the second component, a compound having an amine group, a guanidine group, or the like may form a salt with hydrochloric acid, citric acid, or the like. The second component can be used in one kind or in a plurality of kinds. When using a plurality of kinds, the polysaccharides only or the derivatives thereof only, or a mixture of the polysaccharides and the derivative thereof may be used.

As a viscosity of the polysaccharides and the derivative thereof concerning the invention is higher, a more uniform dispersibility is obtained for a long period of time because precipitation of metal nanowires and metal nanotubes is suppressed. Furthermore, a higher conductivity is obtained because a higher silver nanowire density with a thicker film is obtained. On the other hand, as the viscosity is lower, flatness and uniformity of the coating are more satisfactory. As described above, as the viscosity of the polysaccharides and the derivative thereof concerning the invention, a viscosity at 20° C. of a 2.0 wt. % aqueous solution is preferably in the range of approximately 4,000 mPa·s to approximately 1,000,000 mPa·s, further preferably, in the range of approximately 10,000 mPa·s to approximately 200,000 mPa·s.

For example, with regard to hydroxypropyl methyl cellulose, weight average molecular weight is preferably in the range of approximately 300,000 to approximately 3,000,000, further preferably, in the range of approximately 400,000 to approximately 900,000. Viscosity is proportional to molecular weight, and when a solution having an identical concentration is measured under identical conditions, a material having a higher viscosity has a higher molecular weight, and a material having a lower viscosity has a lower molecular weight.

From a viewpoint of a good dispersibility, a high transmittance, film forming properties and adhesion relative to the first component in the composition, content of the second component is preferably in the range of approximately 50 parts by weight to approximately 300 parts by weight, further preferably, in the range of approximately 75 parts by weight to approximately 250 parts by weight, still further preferably, in the range of approximately 100 parts by weight to approximately 200 parts by weight, based on 100 parts by weight of the first component. The content of the second component is preferably in the range of approximately 0.005% by weight to approximately 3.0% by weight, further preferably, in the range of approximately 0.0375% by weight to approximately 1.875% by weight, still further preferably, in the range of approximately 0.1% by weight to approximately 1.0% by weight, based on the total weight of the coating forming composition.

As a commercial product, Metolose 90SH-100000, Metolose 90SH-30000, Metolose 90SH-15000, Metolose 90SH-4000, Metolose 65SH-15000, Metolose 65SH-4000, Metolose 60SH-10000, Metolose 60SH-4000, Metolose SM-8000 and Metolose SM-4000 (trade names) (made by Shin-Etsu Chemical Co., Ltd.), Methocel K100M, Methocel K15M, Methocel K4M, Methocel F4M, Methocel E10M and Methocel E4M (trade names) (made by the Dow Chemical Company) can be used, for example.

### 1-3. Third Component: Active Methylene Compound

The coating forming composition of the invention contains an active methylene compound as the third component. The third component reacts with the electrophilic compound as the fourth component during bake and is crosslinked to reduce water solubility and simultaneously increase physical strength of the film. The third component causes an increase in physical strength and an improvement in a degree of decrease in water solubility by crosslinking without adversely affecting dispersibility of the first component in the composition. Furthermore, the third component causes an increase in the physical strength and an improvement in a degree of decrease in water solubility by crosslinking without destroying the network formed by the first component in the coating and without decreasing conductivity and optical characteristics. The third component causes an improvement in environmental reliability, suitability for process and adhesion as accompanied therewith.

“Active methylene compound” herein is a compound having one or more active methylene groups.

“Active methylene group” herein is a methylene group (—CH₂—) located between two electron attractive groups. Specific examples of electron attractive groups of the active methylene compound include a carbonyl group (—C(═O)—), an ester group (RO—C(═O)—), a cyano group (N≡C—), a nitro group (O₂N—), a sulfonyl group (R—S(═O)₂—), a sulfinyl group (R—S(═O)—) and a phosphono group ((RO)₂P(═O)—). The active methylene group may be located between electron attractive groups of the same kind, or between electron attractive groups of different kinds.

Specific examples of functional groups having the active methylene group include a 1,3-dicarbonyl group (—C(═O)—CH₂—C(═O)—) such as an acetoacetyl group (—O—C(═O)—CH₂—C(═O)—CH₃) and a malonate group (—O—C(═O)—CH₂—C(═O)—O—). As an active methylene group, the acetoacetyl group or the 1,3-dicarbonyl group are preferred, and the acetoacetyl group is further preferred.

As the active methylene compound being the third component, a compound having a 1,3-dicarbonyl group is preferred, polyvinyl alcohol having a 1,3-dicarbonyl group and poly (meth)acrylate having a 1,3-dicarbonyl group are further preferred, polyvinyl alcohol having an acetoacetyl group and poly(meth)acrylate having the 1,3-dicarbonyl group is still further preferred, and polyvinyl alcohol having the acetoacetyl group is particularly preferred.

“(Meth)acrylate” herein is used as a generic term for acrylate, and methacrylate corresponding thereto.

Specific examples of the active methylene compounds as the third component include Gohsefimer Z-100, Gohsefimer Z-200, Gohsefimer Z-205, Gohsefimer Z-210, Gohsefimer Z-220, Gohsefimer Z-300, Gohsefimer Z-320, Gohsefimer Z-410, Gohsefimer OSK-3551, Gohsefimer OSK-3540 (trade names) (the Nippon Synthetic Chemical Industry Co., Ltd.), and a compound obtained by polymerization, as one component, ethylene glycol monoacetoacetate monomethacrylate and ethylene glycol monoacetoacetate monomethacrylate.

From a viewpoint of the increase in physical strength and decrease in water solubility, content of the third component is preferably in the range of approximately 5.0 parts by weight to approximately 300 parts by weight, further preferably, in the range of approximately 10 parts by weight to approximately 250 parts by weight, still further preferably, in the range of approximately 25 parts by weight to approximately 200 parts by weight, based on 100 parts by weight of the first component. The content of the third component is preferably in the range of approximately 0.0005% by weight to approximately 3.0% by weight, further preferably, in the range of approximately 0.005% by weight to approximately 1.875% by weight, still further preferably, in the range of approximately 0.025% by weight to approximately 1.0% by weight, based on the total weight of the coating forming composition.

### 1-4. Fourth Component: Electrophilic Compound

The coating forming composition of the invention contains the electrophilic compound as the fourth component. The fourth component reduces water solubility and simultaneously causes an increase in physical strength of the film by forming crosslinking among the second component, third component and fourth component of the invention during bake. Crosslinking uniformly exists wholly in the film, and contributes to increasing strength. In the transparent conductive film of the invention, crosslinking is more uniform, as compared with the transparent conductive film that has been used so far, and therefore peeling on a film interface does not occur. A decrease in water solubility of the film by crosslinking prevents a water-soluble solvent from penetration into the film. Thus, an etching phenomenon of parts covered with a photoresist (referred to as underetching) is prevented upon etching, and an applicable range (margin) of a concentration, temperature or immersion time of an etchant is extended.

“Electrophilic compound” herein is a molecule having a positively charged part. Specific examples include an alkyl halide compound, a carboxylic acid halide, an isocyanate compound, an epoxy compound, an aldehyde compound, an amine compound and a methylol compound.

The fourth component causes an increase in physical strength and a decrease in water solubility due to thermal crosslinking, and an improvement in environmental reliability, suitability for process and adhesion as associated therewith out adversely affecting dispersibility of the first component in the composition, without destroying the network formed by the first component of the composition of the invention in the coating obtained from the composition, and without decreasing conductivity and optical characteristics.

In addition, the fourth component does not need to react with all of the second component and the third component, and only needs to react with part of the second component and the third component.

The electrophilic compound as the fourth component is preferably an isocyanate compound, an epoxy compound, an aldehyde compound, an amine compound and a methylol compound, further preferably, a methylol compound, still further preferably, a protected methylol compound. The coating forming composition of the invention may contain one kind or more kinds of electrophilic compounds.

“Isocyanate compound” herein is a compound having an isocyanate group, a (blocked) isocyanate group in which the isocyanate group is protected by an arbitrary protective group, and an amineimide group being a precursor of an isocyanate group.

“Epoxy compound” herein is a compound having an epoxy group and an oxetanyl group.

“Aldehyde compound” herein is a compound having an aldehyde group.

“Amine compound” herein is a compound having an amino group, a protected amino group in which the amino group is protected by a urethane protective group such as a t-butoxycarbonyl group, a benzyloxycarbonyl group and a fluorenyl methyloxy carbonyl group, and an amine salt formed by the amino group and an anion.

“Methylol compound” herein is a compound having an N-methylol group and an N-methylol ether group in which the N-methylol group is protected by an arbitrary alcohol.

From a viewpoint of the environmental reliability, suitability for process and adhesion of the resultant transparent conductive film, content of the fourth component is preferably in the range of approximately 1.0 part by weight to approximately 100 parts by weight, further preferably, in the range of approximately 2.5 parts by weight to approximately 50 parts by weight, still further preferably, in the range of approximately 5.0 parts by weight to approximately 25 parts by weight, based on 100 parts by weight of the total weight of the second component and the third component.

The content of the fourth component is preferably in the range of approximately 0.000055% by weight to approximately 6.0% by weight, further preferably, in the range of approximately 0.0010625% by weight to approximately 1.875% by weight, still further preferably, in the range of approximately 0.00625% by weight to approximately 0.5% by weight, based on the total weight of the coating forming composition.

### 1-4-1. Isocyanate Compounds

Specific examples of the isocyanate compounds that can be used as the fourth component of the invention include hexamethylene diisocyanate, tolylene diisocyanate, isophorone diisocyanate, diphenylmethane diisocyanate, 1,3-bis(isocyanatomethyl)benzene, 1,3-bis(isocyanatomethyl)cyclohexane, 2-iso cyanato ethyl (meth)acrylate, 2-(O-[1′-methylpropylideneamino]carboxyamino)ethyl methacrylate, 2-[(3,5-dimethylpyrazolyl)carbonylamino]ethyl methacrylate, 1,1-(bisacryloyloxy methyl)ethylisocyanate, a compound in which an isocyanate group of the compound described above is protected, a compound prepared by adopting the compound described above as one component, and a mixture thereof.

As the isocyanate compound that can be used as the fourth component of the invention, various kinds of commercial products can be used. Specific examples include Takenate 500 and Takenate 600 (trade names) (Mitsui Chemicals, Inc.), Duranate 24A-100, Duranate 21S-75E, Duranate 22A-75PX, Duranate 18H-70B, Duranate TPA-100, Duranate MFA-75B, Duranate TSA-100, Duranate TLA-100, Duranate TSE-100, Duranate TSS-100, Duranate TKA-100, Duranate MHG-80B, Duranate TSE-100, Duranate E402-90T, Duranate P301-75E, Duranate E405-80T, Duranate D101, Duranate D201, Duranate 17B-60PX, Duranate MF-B60X, Duranate E402-B80T, Duranate TPA-B80E, Duranate MF-K60X, Duranate WB40-100, Duranate WB40-80D, Duranate WE50-100, Duranate WT30-100, Duranate WT20-100 and Duranate 50 M-HDI (trade names) (Asahi Kasei Corporation), Elastron BN-69, Elastron BN-37, Elastron BN-45, Elastron BN-77, Elastron BN-04, Elastron BN-27, Elastron BN-11, Elastron E-37, Elastron H-3, Elastron BAP, Elastron C-9, Elastron C-52, Elastron F-29, Elastron H-38, Elastron MF-9, Elastron MF-25K, Elastron MC, Elastron NEW BAP-15, Elastron TP-26S, Elastron W-11P, Elastron W-22 and Elastron S-24 (trade names) (Dai-Ichi Kogyo Seiyaku Co., Ltd.), Karenz MOI, Karenz AOI, Karenz MOI-BM, Karenz MOI-BP and Karenz BEI (trade names) (Showa Denko K.K.), and Trixene Blocked Isocyanates 214, Trixene Blocked Isocyanates 7986, Trixene Blocked Isocyanates 327, Trixene Blocked Isocyanates 7950, Trixene Blocked Isocyanates 7951, Trixene Blocked Isocyanates 7960, Trixene Blocked Isocyanates 7961, Trixene Blocked Isocyanates 7982, Trixene Blocked Isocyanates 7990, Trixene Blocked Isocyanates 7991 and Trixene Blocked Isocyanates 7992 (trade names) (Baxenden Chemicals, Ltd).

The isocyanate compounds may be used in one kind or in combination with two or more kinds.

### 1-4-2. Epoxy Compound

Specific examples of the epoxy compounds that can be used as the fourth component of the invention include a phenol novolak, cresol novolak, bisphenol A, bisphenol F, hydrogenated bisphenol A, hydrogenated bisphenol F, bisphenol S, trisphenol methane, tetraphenol ethane, bixylenol or biphenol epoxy compound, an alicyclic or heterocyclic epoxy compound, an epoxy compound having a dicyclopentadiene or naphthalene structure, a homopolymer of N,N,N′,N′-tetraglycidyl-m-xylenediamine, 1,3-bis(N,N-diglycidyl aminomethyl)cyclohexane, N,N,N′,N′-tetraglycidyl-4,4′-diaminodiphenylmethane or glycidyl methacrylate, a copolymer of glycidyl methacrylate and any other radically polymerizable and monofunctional monomer, a homopolymer of 3-ethyl-3-methacryloyloxymethyloxetane, and a copolymer of 3-ethyl-3-methacryloyloxymethyloxetane and any other radically polymerizable monofunctional monomer.

As the epoxy compound that can be used as the fourth component of the invention, various kinds of commercial products can be used. Specific examples include TECHMORE VG3101L (trade name) (Mitsui Chemicals, Inc.), jER828, jER834, jER1001, jER1004, jER152, jER154, jER807, YL-933, YL-6056, YX-4000, YL-6121 and JER157S (trade names) (Mitsubishi Chemical Corporation), YL-931 (trade name) (Mitsubishi Chemical Corporation), Epiclon 840, Epiclon 850, Epiclon 1050, Epiclon 2055, Epiclon N-730, Epiclon N-770, Epiclon N-865, Epiclon 830, EXA-1514, HP-4032, EXA-4750, EXA-4700, HP-7200 and HP-7200H, HP-7200HH (trade names) (DIC Corporation), Epotohto YD-011, Epotohto YD-013, Epotohto YD-127, Epotohto YD-128, Epotohto YDCN-701, Epotohto YDCN-704, Epotohto YDF-170, Epotohto ST-2004, Epotohto ST-2007 and Epotohto ST-3000 (trade names) (Nippon Steel Chemical Co., Ltd.), D.E.R.317, D.E.R.331, D.E.R.661, D.E.R.664, D.E.R.431 and D.E.R.438 (trade names) (the Dow Chemical Co.), Araldite 6071, Araldite 6084, Araldite GY250, Araldite GY260, Araldite ECN1235, Araldite ECN1273, Araldite ECN1299, YDF-175, YDF-2001, YDF-2004, Araldite XPY306, Araldite CY175, Araldite CY179, Araldite PT810 and Araldite 163 (trade names) (BASF Japan, Ltd.), Sumi-Epoxy ESA-011, Sumi-Epoxy ESA-014, Sumi-Epoxy ELA-115, Sumi-Epoxy ELA-128, Sumi-Epoxy ESCN-195× and Sumi-Epoxy ESCN-220 (trade names) (Sumitomo Chemical Co., Ltd.), A.E.R.330, A.E.R.331, A.E.R.661 and A.E.R.664 (trade names) (Asahi Chemical Corporation), XPY307, EPPN-201, EPPN-501, EPPN-502, EOCN-1025, EOCN-1020, EOCN-104S, RE-306 and EBPS-200 (trade names) (Nippon Kayaku Co., Ltd.), A.E.R.ECN-235, A.E.R.ECN-299 and EPX-30 (trade names) (ADEKA Corporation), Celloxide 2021 (trade name) (Daicel Corporation) and TEPIC (trade name) (Nissan Chemical Industries, Ltd.).

The epoxy compounds may be used in one kind or in combination with two or more kinds.

### 1-4-2-1. Epoxy Curing Agent

When the coating forming composition of the invention contains the epoxy compound, the composition may further contain an epoxy curing agent in view of further improving a chemical resistance thereof. As the epoxy curing agent, an acid anhydride curing agent, a polyamine curing agent, a catalyst curing agent or the like is preferred.

Specific examples of the acid anhydride curing agents include maleic anhydride, tetrahydrophthalic anhydride, hexahydrophthalic anhydride, methylhexahydrophthalic anhydride, hexahydrotrimellitic anhydride, phthalic anhydride, trimellitic anhydride and a styrene-maleic anhydride copolymer.

Specific examples of the polyamine curing agents include diethylenetriamine, triethylenetetramine, tetraethylenepentamine, dicyandiamide, polyamideamine (polyamide resin), a ketimine compound, isophorone diamine, m-xylenediamine, m-phenylenediamine, 1,3-bis(aminomethyl)cyclohexane, N-aminoethylpiperazine, 4,4′-diaminodiphenylmethane, 4,4′-diamino-3,3′-diethyldiphenylmethane and diaminodiphenylsulfone.

Specific examples of the catalyst curing agents include a tertiary amine compound and an imidazole compound.

The epoxy curing agents may be used in one kind or in combination with two or more kinds.

### 1-4-3. Aldehyde Compound

Specific examples of the aldehyde compounds that can be used as the fourth component of the invention include formaldehyde, paraformaldehyde, trioxane, hexamethylenetetramine, glyoxal and glyoxal-crosslinked starch.

As the aldehyde compound that can be used as the fourth component of the invention, various kinds of commercial products can be used. Specific examples include GX (trade name) (the Nippon Synthetic Chemical Industry Co., Ltd.), Sequarez 755 and Sunrez 700M (trade names) (Omnova Solutions Inc.).

The aldehyde compounds may be used in one kind or in combination with two or more kinds.

### 1-4-4. Amine Compound

Specific examples of the amine compounds that can be used as the fourth component of the invention include hexamethylenediamine, m-xylylenediamine, 1,3-bis(aminomethyl)cyclohexane and hexamethylenetetramine. Moreover, a salt may be formed using an arbitrary acid.

As the amine compound that can be used as the fourth component of the invention, various kinds of commercial products can be used. Specific examples include MXDA and 1,3-BAC (trade names) (Mitsubishi Gas Chemical Co., Inc.).

The amine compounds may be used in one kind or in combination with two or more kinds.

### 1-4-5. Methylol Compound

Specific examples of the methylol compounds that can be used as the fourth component of the invention include a novolak resin obtained by a condensation reaction between an aromatic compound having a phenolic hydroxyl group and aldehydes, a homopolymer of vinylphenol (including a hydrogenated product), a vinylphenol copolymer between vinylphenol and a compound that can be copolymerized therewith (including a hydrogenated product), a methylolurea resin, a hexamethylolmelamine resin, a hexamethoxymethylolmelamine resin, a methylolmelamine resin, an etherified methylolmelamine resin, a benzoguanamine resin, a methylolbenzoguanamine resin, an etherified methylol benzoguanamine resin, and a condensate thereof. Among the compounds described above, a methylolmelamine resin and an etherified methylol melamine resin both being a methylol compound are preferred in view of water solubility before crosslinking and a good suitability for process and a good environmental reliability after film formation. Furthermore, an etherified methylolmelamine resin being a protected methylol compound is further preferred in view of a good storage stability of the composition.

As the methylol compound that can be used as the fourth component of the invention, various kinds of commercial products can be used. Specific examples include TD-4304, PE-201L, PE-602L (trade name) (DIC Corporation), Shonol BRL-103, BRL-113, BRP-408A, BRP-520, BRL-1583 and BRE-174 (trade names) (Showa Denko K. K.), Riken Resin RG-80, Riken Resin RG-10, Riken Resin RG-1, Riken Resin RG-1H, Riken Resin RG-85, Riken Resin RG-83, Riken Resin RG-17, Riken Resin RG-115E, Riken Resin RG-260, Riken Resin RG-20E, Riken Resin RS-5S, Riken Resin RS-30, Riken Resin RS-150, Riken Resin RS-22, Riken Resin RS-250, Riken Resin RS-296, Riken Resin HM-272, Riken Resin HM-325, Riken Resin HM-25, Riken Resin MA-156, Riken Resin MA-100, Riken Resin MA-31, Riken Resin MM-3C, Riken Resin MM-3, Riken Resin MM-52, Riken Resin MM-35, Riken Resin MM-601, Riken Resin MM-630, Riken Resin MS and Riken Resin MM-65S (trade names) (Mild Riken Industry), Beckamine NS-11, Beckamine LF-K, Beckamine LF-R, Beckamine LF-55P concentrated, Beckamine NS-19, Beckamine FM-28, Beckamine FM-7, Beckamine NS-200, Beckamine NS-210L, Beckamine FM-180, Beckamine NF-3, Beckamine NF-12, Beckamine NF-500K, Beckamine E, Beckamine N-13, Beckamine N-80, Beckamine J-300S, Beckamine N, Beckamine APM, Beckamine MA-K, Beckamine MA-S, Beckamine J-101, Beckamine J-101LF, Beckamine M-3, Beckamine M-3 (60), Beckamine A-1, Beckamine R-25H, Beckamine V-60 and Beckamine 160 (trade names) (DIC Corporation), Nikaresin S-176 and Nikaresin 260 (trade names) (Nippon Carbide Industries Co., Inc.), and Nikalac MW-30M, Nikalac MW-30, Nikalac MW-22, Nikalac MX-730, Nikalac MX-706, Nikalac MX-035, Nikalac MX-45 and Nikalac BX-4000 (trade names) (Sanwa Chemical Co., Ltd.).

The methylol compounds may be used in one kind or in combination with two or more kinds.

### 1-4-5-1. Catalyst and a Reaction Initiator

When the coating forming composition of the invention contains the methylol compound, the coating forming composition may contain a catalyst or a reaction initiator in order to further improve curing properties. Specific examples of such a catalyst include organic acids such as an aromatic sulfonic acid compound or a phosphoric acid compound, and a salt thereof, an amine compound, salts of the amine compound, an imine compound, an amidine compound, a guanidine compound, a heterocyclic compound containing a N atom, an organometallic compound, and metal salts such as zinc stearate, zinc myristate, aluminum stearate and calcium stearate. Specific examples of the reaction initiators include a photoacid generator and a photobase generator.

The catalysts and the reaction initiators may be used in one kind or in combination with two or more kinds. Moreover, a catalyst and a reaction initiator based on a different mechanism may also be used.

From a viewpoint of reactivity, a good dispersibility of each component in the composition, and a high conductivity, a good optical transmission, a good environmental reliability, a good suitability for process and a good adhesion of the coating obtained from the composition of the invention, content of the catalyst and content of the reaction initiator in the coating forming composition of the invention is preferably approximately 0.1 part by weight to approximately 100 parts by weight, further preferably, approximately 1 part by weight to approximately 50 parts by weight, still further preferably, approximately 5 parts by weight to approximately 25 parts by weight, based on 100 parts by weight of the methylol compound.

As the catalyst and the reaction initiator, various kinds of commercial products can be used. Specific examples include Riken Fixer RC, Riken Fixer RC-3, Riken Fixer RC-12, Riken Fixer RCS, Riken Fixer Rc-W, Riken Fixer MX, Riken Fixer MX-2, Riken Fixer MX-18, Riken Fixer MX-18N, Riken Fixer MX-36, Riken Fixer MX-15, Riken Fixer MX-25, Riken Fixer MX-27N, Riken Fixer MX-051, Riken Fixer MX-7, Riken Fixer DMX-5, Riken Fixer LTC-66, Riken Fixer RZ-5, Riken Fixer XT-329, Riken Fixer XT-318, Riken Fixer XT-53, Riken Fixer XT-58 and Riken Fixer XT-45, (trade names) (Mikiriken Industrial Co., Ltd.), Catalyst 376, Catalyst ACX, Catalyst O, Catalyst M, Catalyst X-80, Catalyst C, Catalyst X-60, Catalyst GT, Catalyst X-110, Catalyst GT-3, Catalyst NFC-1 and Catalyst ML (trade names) (DIC Corporation), and Nacure 155, Nacure 1051, Nacure 5076, Nacure 4054J, Nacure 2500, Nacure 5225, Nacure X49-110, Nacure 3525 and Nacure 4167 (trade names) (KING INDUSTRIES, INC.).

### 1-5. Fifth Component: Solvent

The coating forming composition of the invention contains the solvent as the fifth component. In the coating forming composition of the invention, the first component to the fourth component are uniformly dispersed or uniformly dissolved in the solvent. Specific examples of the solvent include water, methanol, ethanol, isopropyl alcohol, 1-butanol, 2-butanol, 2-methyl-1-propanol, t-butyl alcohol, pentyl alcohol, 1-methoxy-2-propanol, ethylene glycol, 1,2-propanediol, 1,3-propanediol and glycerol. However, the solvent is not limited thereto. Moreover, the solvents may be used alone or may be mixed.

The solvent used for the coating forming composition of the invention preferably has a boiling point in the range of approximately 40° C. to approximately 300° C., further preferably, in the range of approximately 50° C. to approximately 250° C., still further preferably, in the range of approximately 60° C. to approximately 200° C.

Content of the solvent is preferably in the range of approximately 87.0% by weight to approximately 99.98% by weight, further preferably, in the range of approximately 95.0% by weight to approximately 99.98% by weight, still further preferably, in the range of approximately 99.0% by weight to approximately 99.98% by weight, based on the total weight of the coating forming composition.

### 1-6. Arbitrary Component

The coating forming composition of the invention may contain an arbitrary component within the range in which properties of the composition are not adversely affected. Specific examples of the arbitrary components include a binder component other than the second component, a corrosion inhibitor, a adhesion accelerator, a surfactant and a viscosity modifier.

1-6-1. Binder Component Other than the Second Component

As the binder component, various polymer compounds other than the second component and a gelling agent can also be used.

Specific examples of various polymer compounds used as the binder component include a vinyl compound such as polyvinyl acetate, polyvinyl alcohol and polyvinyl formal, a biopolymer compound such as protein, gelatin and polyamino acid, a polyacryloyl compound such as polymethylmethacrylate, polyacrylate and polyacrylonitrile, a polyester such as polyethylene terephthalate, polyester naphthalate and polycarbonate, polystyrene, polyvinyl toluene, polyvinyl xylene, polyimide, polyamideimide, polyether imide, polysulfide, polysulfone, polyphenylene, polyphenyl ether, polyurethane, epoxy (meth)acrylate, melamine (meth)acrylate, a polyolefin such as polypropylene, polymethylpentane and cyclic olefin, an acrylonitrile-butadiene-styrene copolymer (ABS), a silicone resin, polyvinyl chloride, chlorinated polyethylene, chlorinated polypropylene, polyacetate, polynorbornene, synthetic rubber, a fluorinated polymer such as polyfluorovinylidene, polytetrafluoroethylene and polyhexafluoropropylene, a fluoroolefin-hydrocarbon olefin copolymer and a fluorocarbon polymer. However, the binder component is not limited thereto.

Specific examples of the gelling agents used as the binder component include metal soap, 12-hydroxystearic acid, dibenzylidenesorbitol, N-acylamino acid amide, N-acylamino acid ester and a N-acylamino acid amine salt. However, the gelling agent is not limited thereto.

### 1-6-2. Corrosion Inhibitor

As the corrosion inhibitor, a specific nitrogen-containing organic compound and a specific sulfur-containing organic compound such as aromatic triazole, imidazole, thiazole and thiol, a biomolecule showing a specific affinity with a metal surface, a compound for blocking a corrosive element by competing with a metal or the like are known. Moreover, metal nanowires may be protected based on a different mechanism by a different corrosion inhibitor.

Specific examples of the corrosion inhibitors include alkyl-substituted benzotriazole such as tolyltriazole and butylbenzyltriazole, 2-aminopyrimidine, 5,6-dimethylbenzimidazole, 2-amino-5-mercapto-1,3,4-thiadiazole, 2-mercaptopyrimidine, 2-mercaptobenzoxazole, 2-mercaptobenzothiazole, 2-mercaptobenzimidazole, cysteine, dithiothiadiazole, saturated C6 to C24 linear alkyl dithiothiadiazole, saturated C6 to C24 linear alkylthiol, triazine and n-chlorosuccinimide, but not limited thereto. Moreover, the corrosion inhibitors may be used in one kind or in combination with two or more kinds.

### 1-6-3. Adhesion Promoter

As the adhesion promoter, a compound that forms a bond between the substrate and the component in the composition, a compound that has a functional group showing affinity with the substrate and the component in the composition, and so forth are known. Moreover, the adhesion may be promoted based on a different mechanism by a different adhesion promoter.

Specific examples of the adhesion accelerators include a silane coupling agent such as 3-(3-aminopropyl)triethoxysilane, 3-(3-mercaptopropyl)trimethoxysilane and 3-methacryloyloxy propyltrimethoxysilane, but not limited thereto. Moreover, the adhesion accelerators may be used in one kind or in combination with two or more kinds.

### 1-6-4. Surfactant

The coating forming composition of the invention may contain the surfactant for improving wettability to a base substrate or uniformity of a surface of the resultant cured layer, for example. The surfactants are classified according to a structure of a hydrophilic group into an ionic surfactant and a nonionic surfactant, and further according to a structure of a hydrophobic group into an alkyl surfactant, a silicone surfactant and a fluorine surfactant. Moreover, the surfactants are classified according to a molecular structure into a monomolecular surfactant that has a relatively small molecular weight and a simple structure, and a macromolecule surfactant that has a large molecular weight and has a side chain and a branch. The surfactants are classified according to a composition into a single surfactant, and a mixed surfactant in which two or more kinds of surfactants and base materials are mixed. All kinds of surfactants can be used as the surfactant to be added to the coating forming composition of the invention.

Specific examples of commercial products of the surfactants include Zonyl FSO-100, Zonyl FSN, Zonyl FSO and Zonyl FSH (trade names) (E. I. du Pont de Nemours & Co.), Triton X-100, Triton X-114 and Triton X-45 (trade names) (Sigma-Aldrich Japan K.K.), Dynol 604 and Dynol 607 (trade names) (Air Products Japan, Inc.), n-dodecyl-β-D-maltoside, Novek, Byk-300, Byk-306, Byk-335, Byk-310, Byk-341, Byk-344, Byk-370, Byk-354, Byk-358 and Byk-361 (trade names) (BYK-Chemie Japan K.K.), DFX-18, Futargent 250 and Futargent 251 (trade names) (Neos Co., Ltd.), and Megafac F-479 and Megafac F-472SF (trade names) (DIC Corporation). However, the surfactant is not limited thereto. Moreover, the surfactants may be used in one kind or in combination with two or more kinds.

### 1-6-5. Viscosity Modifier

The coating forming composition of the invention may contain the viscosity modifier for improving wettability to the base substrate or uniformity of the surface of the resultant cured film, for example. Specific examples of the viscosity modifiers include a polyether, urethane-modified polyether, modified polyacrylic acid or modified polyacrylate compound, but are not limited thereto. Moreover, the viscosity modifier may be used alone or may be mixed.

### Composition and Physical Properties of the Coating Forming Composition

The coating forming composition of the invention is a composition in which the first component to the fourth component and the arbitrary component are uniformly dispersed or dissolved in the solvent being the fifth component.

From a viewpoint of a good dispersibility of each component in the composition, and a high conductivity, a good optical transmission, a good environmental reliability, a good suitability for process and a good adhesion of the coating obtained from the composition of the invention, preferably, the content of the first component is in the range of approximately 0.01% by weight to approximately 1.0% by weight based on the total weight of the coating forming composition, the content of the second component is in the range of approximately 50 parts by weight to approximately 300 parts by weight based on 100 parts by weight of the first component, the content of the third component is in the range of approximately 5.0 parts by weight to approximately 300 parts by weight based on 100 parts by weight of the first component, and the content of the fourth component is in the range of approximately 1.0 part by weight to approximately 100 parts by weight based on 100 parts by weight of the total weight of the second component and the third component, further preferably, the content of the first component is in the range of approximately 0.05% by weight to approximately 0.75% by weight based on the total weight of the coating forming composition, the content of the second component is in the range of approximately 75 parts by weight to approximately 250 parts by weight based on 100 parts by weight of the first component, the content of the third component is in the range of approximately 10 parts by weight to approximately 250 parts by weight based on 100 parts by weight of the first component, and the content of the fourth component is in the range of approximately 2.5 parts by weight to 50 parts by weight based on 100 parts by weight of the total weight of the second component and the third component, still further preferably, the content of the first component is in the range of approximately 0.1% by weight to approximately 0.5% by weight based on the total weight of the coating forming composition, the content of the second component is in the range of approximately 100 parts by weight to 200 parts by weight based on 100 parts by weight of the first component, the content of the third component is in the range of approximately 25 parts by weight to approximately 200 parts by weight based on 100 parts by weight of the first component, and the content of the fourth component is in the range of approximately 5.0 parts by weight to approximately 25 parts by weight based on 100 parts by weight of the total weight of the second component and the third component.

More specifically, as for the content of each component based on the total weight of the composition, preferably, the content of the first component is in the range of approximately 0.01% by weight to approximately 1.0% by weight, the content of the second component is in the range of approximately 0.005% by weight to approximately 3.0% by weight, the content of the third component is in the range of approximately 0.0005% by weight to approximately 3.0% by weight, and the content of the fourth component is in the range of approximately 0.000055% by weight to approximately 6.0% by weight, further preferably, the content of the first component is in the range of approximately 0.05% by weight to approximately 0.75% by weight, the content of the second component is in the range of approximately 0.0375% by weight to approximately 1.875% by weight, the content of the third component is in the range of approximately 0.005% by weight to approximately 1.875% by weight, and the content of the fourth component is in the range of approximately 0.0010625% by weight to approximately 1.875% by weight, still further preferably, the content of the first component is in the range of approximately 0.1% by weight to approximately 0.5% by weight, the content of the second component is in the range of approximately 0.1% by weight to approximately 1.0% by weight, the content of the third component is in the range of approximately 0.025% by weight to approximately 1.0% by weight, and the content of the fourth component is in the range of approximately 0.00625% by weight to approximately 0.5% by weight.

The coating forming composition of the invention can be manufactured by appropriately selecting agitating, mixing, heating, cooling, dissolving, dispersing or the like of the components as described above according to a publicly known method.

As the viscosity of the coating forming composition of the invention is higher, precipitation of the metal nanowires and the metal nanotubes is suppressed, and a more uniform dispersibility is obtained for a long period of time. Moreover, as the viscosity is higher, a film having a higher conductivity can be obtained because film thickness can be increased under fixed application conditions. On the other hand, as the viscosity is lower, flatness and uniformity of the coating is better. Thus, the viscosity at 25° C. of the coating forming composition of the invention is preferably in the range of approximately 1 mPa·s to approximately 100 mPa·s, further preferably, in the range of approximately 10 mPa·s to approximately 70 mPa·s. In the invention, the viscosity is expressed by means of a value measured by using a cone plate type rotational viscometer.

### Method for Manufacturing a Substrate Having a Transparent Conductive Film

The substrate having the transparent conductive film can be manufactured by using the coating forming composition of the invention. The method for manufacturing the substrate includes a process for forming the coating on the substrate by applying the composition described above onto the substrate, and then heating the substrate at a temperature in the range of approximately 40° C. to approximately 240° C. Heating may be performed only once, or twice or more at different temperatures.

The coating having the conductivity, the environmental reliability and the suitability for process is formed on the substrate by applying the composition onto the substrate, and then applying bake.

The substrate may be hard or flexible. Moreover, the substrate may be colored. Specific examples of materials of the substrate include glass, polyimide, polycarbonate, polyethersulfone, acryloyl, polyester, polyethylene terephthalate, polyethylene naphthalate, polyolefin, polyvinyl chloride, and a product prepared by impregnating the resin described above into glass fibers or the like and forming a plate. The materials preferably have a high optical transmittance and a low haze value. Furthermore, a circuit such as a TFT device may be preferably formed on the substrate, or a color filter, an organic functional material such as and an overcoat, or an inorganic functional material such as a silicon nitride or silicon oxide film may be formed thereon. Moreover, a number of layers may be laminated on the substrate.

As a method for applying the composition of the invention onto the substrate, a general method cab be applied, such as a spin coating method, a slit coating method, a dip coating method, a blade coating method, a spray method, a screen printing method, a relief printing method, an intaglio printing method, a planographic printing method, a dispensing method and an ink jet method. From a viewpoint of uniformity of the film thickness and productivity, the spin coating method and the slit coating method are preferred, and the slit coating method is further preferred.

Surface resistance is determined depending on an application.

The surface resistance is determined depending on the film thickness and surface density of the first component. The film thickness and the surface density of the first component are determined depending on viscosity and a concentration of the first component in the coating forming composition. The film thickness is determined depending on application conditions. Accordingly, a desired surface resistance is controlled by the viscosity, the concentration of the first component in the coating forming composition, and application conditions.

A larger film thickness is better from a viewpoint of a low surface resistance, and a smaller film thickness is better from a viewpoint of good optical characteristics. Therefore, when comprehensively taking the facts into consideration, the film thickness is preferably in the range of approximately 1 nanometer to approximately 500 nanometers, further preferably, in the range of approximately 5 nanometers to approximately 250 nanometers, still further preferably, in the range of approximately 10 nanometers to approximately 150 nanometers.

The solvent is removed by performing heating treatment of an applied article when necessary. As heating temperature, heating is ordinarily performed at a temperature in the range of approximately 30° C. to approximately a boiling point of the solvent plus 50° C., although the range is different depending on kinds of solvents.

The surface resistance and the total transmittance of the resultant film can be adjusted to a desired value by adjusting the film thickness or an applied amount of the composition, conditions of the application method, and the concentration of the first component in the coating forming composition of the invention.

In general, as the film thickness is larger, the surface resistance and the total transmittance are decreased. Moreover, as the concentration of the first component in the coating forming composition is higher, the surface resistance and the total transmittance are decreased.

The coating obtained as described above has preferably a surface resistance in the range of approximately 1Ω/□ to approximately 10,000Ω/□ and a total transmittance in the range of approximately 80% or more, further preferably, a surface resistance in the range of approximately 10Ω/□ to approximately 5,000Ω/□ and a total transmittance in the range of approximately 85% or more.

In the invention, unless otherwise noted, the surface resistance is expressed in terms of a measured value according to a non-contact measurement method as described later.

### Patterning of a Transparent Conductive Layer

Patterning of the transparent conductive layer prepared according to the invention can be performed according to the application. As the method therefor, a photolithographic method using a resist material generally used for patterning of ITO can be applied. Procedures of the photolithographic method are shown below.

(Process 1) Resist application

### (Process 2) Bake

### (Process 3) Exposure

### (Process 4) Development

### (Process 5) Etching

### (Process 6) Strip

### Arbitrary Process

Before and after each process of film formation and patterning of the composition described above, a suitable treatment process, a suitable cleaning process and a suitable drying process may be appropriately applied. Specific examples of the treatment processes include plasma surface treatment, ultrasonic treatment, ozone treatment, cleaning treatment using a suitable solvent and heating treatment. Moreover, a process for immersion into water may be applied. Such immersion into water is preferred from a viewpoint of a low surface resistance.

The plasma surface treatment can be applied for improving applicability of the coating forming composition or a developer. For example, the surface of the substrate or the coating forming composition on the substrate can be treated under conditions of 100 W, 90 seconds, an oxygen flow rate of 50 sccm (sccm; standard cc/min) and a pressure of 50 Pa by using oxygen plasma. According to the ultrasonic treatment, particulates physically deposited or the like on the substrate can be removed by immersing the substrate into a solution, and propagating an ultrasonic wave of approximately 200 kHz, for example. According to the ozone treatment, a deposit or the like on the substrate can be effectively removed by blowing air to the substrate and simultaneously irradiating the substrate with ultraviolet light and utilizing oxidizing power of ozone generated by the ultraviolet light. According to the cleaning treatment, a particulate impurity can be washed out and removed by spraying pure water in a mist form or a shower form and utilizing dissolving capability and pressure of the pure water, for example. The heat treatment is a method for removing a compound to be desirably removed in the substrate by volatilizing the compound. Heating temperature is appropriately set up in consideration of a boiling point of the compound to be desirably removed. For example, when the compound to be desirably removed is water, the substrate is heated at a temperature in the range of approximately 50° C. to approximately 150° C.

The surface resistance and the total transmittance of the transparent conductive film on the substrate having a transparent conductive film subjected to patterning as obtained according to the manufacturing method as described above has preferably a surface resistance in the range of approximately 1Ω/□ to approximately 10,000Ω/□ and a total transmittance in the range of approximately 80% or more, further preferably, a surface resistance in the range of approximately 10Ω/□ to approximately 5,000Ω/□ and a total transmittance in the range of approximately 85% or more.

Herein, “total transmittance” is a ratio of transmitted light to incident light, and the transmitted light includes a directly transmitted component and a scattered component. A light source is illuminant C and a spectrum is a CIE luminosity function y. Moreover, the film thickness is preferably in the range of approximately 1 nanometer to approximately 500 nanometers, further preferably, in the range of approximately 5 nanometers to approximately 250 nanometers, still further preferably, in the range of approximately 10 nanometers to approximately 150 nanometers, although the film thickness is different according to the application.

Such surface resistance and total transmittance can be adjusted to a desired value by adjusting the film thickness or an applied amount of the composition and conditions of the application method, and the concentration of the first component in the coating forming composition of the invention.

As for the transparent conductive film subjected to patterning, an insulating film, an overcoat having a protective function or a polyimide layer having an orientation function can be further arranged on the surface thereof.

### Application of the Substrate Having the Transparent Conductive Film Subjected to Patterning

The substrate having the transparent conductive film subjected to patterning is used for a device element because of conductivity and optical properties thereof.

Specific examples of the device elements include a liquid crystal display element, an organic electroluminescence element, an electronic paper, a touch panel element and a photovoltaic cell element.

The device element may be prepared by using a rigid substrate or a flexible substrate or the combination thereof. Moreover, the substrate used for the device element may be transparent or colored.

Specific examples of the transparent conductive films used for the liquid crystal display element include a pixel electrode to be formed on a side of a thin film transistor (TFT) array substrate and a common electrode formed on a side of a color filter substrate. Specific examples of display modes of LCD include Twisted Nematic (TN), Multi Vertical Alignment (MVA), Patterned Vertical Alignment (PVA), In Plane Switching (IPS), Fringe Field Switching (FFS), Polymer Stabilized Vertical Alignment (PSA), Optically Compensated Bend (OCB), Continuous Pinwheel Alignment (CPA) and Blue Phase (BP). Moreover, a transmissive type, a reflective type and a transflective type are provided for each of the modes. The pixel electrode of LCD is subjected to patterning for each pixel, and is electrically connected to a drain electrode of TFT. In addition, the IPS mode has a comb electrode structure, and the PVA mode has a structure in which slits are curved in the pixel, for example.

The transparent conductive film used for the organic electroluminescence element is ordinarily subjected to patterning in a stripe on the substrate, when the film is used as a conductive region of a passive type driving mode. A direct current voltage is applied between the conductive region in the stripe (anode) and a conductive region in a stripe arranged orthogonally thereto (cathode), and thus display is conducted by allowing pixels in the matrix to emit light. When the film is used as an electrode of an active type driving mode, the film is subjected to patterning on the side of the TFT array substrate for each pixel.

The touch panel element includes a resistive film type and a capacitive type depending on a detection method thereof, and a transparent electrode is used for any of the types. The transparent electrode used for the capacitive type is subjected to patterning.

The electronic paper includes a microcapsule type, a quick response liquid powder type, a liquid crystal type, an electrowetting type, an electrophoretic type and a chemical reaction change type depending on a display method thereof, and the transparent electrode is used for any of the types. The transparent electrode is subjected to patterning in an arbitrary shape, respectively.

The photovoltaic cell element includes a silicon type, a compound type, an organic type and a quantum dot type depending on a material of an optical absorption layer, and the transparent electrode is used for any of the types. The transparent electrode is subjected to patterning in an arbitrary shape, respectively.

It will be apparent to those skilled in the art that various modifications and variations can be made in the invention and specific examples provided herein without departing from the spirit or scope of the invention. Thus, it is intended that the invention covers the modifications and variations of this invention that come within the scope of any claims and their equivalents.

The following examples are for illustrative purposes only and are not intended, nor should they be interpreted to, limit the scope of the invention.

### EXAMPLES

In the following, the invention will be further specifically explained by way of Examples, but the invention is in no way limited to the Examples. In Examples and Comparative Examples, ultrapure water was used as water being a constituent. However, the ultrapure water may be simply referred to as water in the following. The ultrapure water was prepared using Puric FPC-0500-0M0 (trade name) (Organo Corporation).

Measurement methods or evaluation methods in each evaluation item were applied according to methods as described below.

Unless otherwise noted, measurements (1) to (4) were carried out in a region in which a transparent conductive film of a sample to be evaluated is formed.

### (1) Measurement of Surface Resistance

As the evaluation method, two kinds of a four-point probe method and a non-contact measurement method were applied.

Loresta-GP MCP-T610 (Mitsubishi Chemical Corporation) was used for the four-point probe measurement method (in accordance with JIS K7194). A probe used for measurement was a proprietary ESP type probe having a distance of 5 millimeters between pins, and a pin point diameter of 2 millimeters. Surface resistance (Ω/□) was calculated by bringing the probe into contact with the sample to be evaluated, measuring a potential difference between two inner terminals when applying a fixed current to two outer terminals, and multiplying resistance obtained by the measurement by a correction coefficient. Volume resistivity (Ω·cm) and conductivity (Siemens/cm) can be determined from the thus obtained surface resistance value and thickness of a conductive film.

According to the four-point probe measurement method, surface resistance of the conductive film on the substrate in which at least one insulating film was formed on the conductive film, and surface resistance of the conductive film in which metal nanowires or metal nanotubes as shown herein were dispersed into an insulator cannot be sometimes stably measured. In the case, a non-contact surface resistance measurement method using an eddy current was applied. As the non-contact measurement method, surface resistance (Ω/□) was measured using 717 B-H (DELCOM). Also in the case, volume resistivity (Ω·cm) and conductivity (Siemens/cm) can be determined from the thus obtained surface resistance value and thickness of the conductive film.

In addition, a measured value according to the four-point probe method and a measured value according to the non-contact measurement method agree substantially. Unless otherwise noted herein, the non-contact measurement method was applied.

### (2) Measurement of Total Transmittance and Haze

Haze-Gard Plus (BYK Gardner, Inc.) was used for measurement of total transmittance and haze. Air was used as a reference.

### (3) Film Thickness

Profilometer P-16+(KLA-Tencor) was used for measurement of film thickness.

The film thickness was measured in accordance with “Test method for thickness of fine ceramic thin films—Film thickness by contact probe profilometer” (JIS R1636). When measuring film thickness of a film not subjected to patterning, part of a film of a sample to be evaluated was shaved off, and a profile on a boundary surface was measured.

### (4) Environmental Reliability Test

Environmental reliability was evaluated by allowing a transparent conductive film to stand in a constant temperature oven at 70° C., and a high temperature and high humidity oven at 70° C. and 90% RH, measuring surface resistance, total transmittance and haze after 500 hours, and comparing measured values with initial values, respectively.

When a rate of change of the surface resistance, the total transmittance and the haze was compared with the initial value, evaluation results were determined to be good when the rates of change of all characteristics were in the range of 0% to 50%, marginal when the rate of change of at least one characteristic was in the range of 51% to 100%, and bad when the rate of change of at least one characteristic was 101% or more.

### (5) Testing of Suitability for Process

Water was sprayed to a sample to be evaluated at a water temperature of 23° C. and a water pressure of 270 kPa for 1 or 5 minutes by using Developer EX-25D (Yoshitani Shoji K. K). Suitability for process was evaluated by performing (a) visual inspection of presence or absence of film peeling, (b) measurement of surface resistance and (c) measurement of total transmittance and haze before and after spraying.

The film was visually observed, and evaluation results were determined to be good when no peeling of the film was observed under conditions of a water temperature of 23° C., a water pressure of 270 kPa and a treatment time of 1 minute, marginal when peeling was observed in an area of 1% or more to 50% of the substrate, and bad when peeling was observed in an area of 51% to 100% of the substrate. A sample rated to be good according to the evaluation results was evaluated under conditions of a water temperature of 23° C., a water pressure of 270 kPa and a treatment time of 5 minutes, and a sample when no peeling of the film was observed was rated to be excellent.

### (6) Measurement of Viscosity of a Composition

As for a viscosity of a composition used in Examples, viscosity when temperature was 25° C. and a shear rate was 100 s⁻¹ was measured using TV-22 Viscometer (Told Sangyo Co., Ltd.).

### (7) Testing of Dispersion Stability of a Composition (Dispersibility)

After putting 10 g of a composition used in Examples in a 20 mL screw vial and sufficiently shaking the vial up, the vial was allowed to stand for one week under room temperature. Precipitation of silver nanowires after allowing the vial to stand was visually confirmed. A composition in which no precipitation of silver nanowires was observed was rated to be good, a composition in which contrasting density was observed was rated to be marginal, and a composition in which precipitation of silver nanowires was observed in a bottom of the screw vial was rated to be bad.

### (8) Adhesion Test

A cross cut test was performed using 3M396 tape and 3M810 tape (trade names) (Sumitomo 3M Co., Ltd.), and the number of residues after tape removal in 100 cross cuts having a size of 1 mm×1 mm was evaluated. A tape in which no peeling was observed was rated to be good, a tape in which peels of 1 or more to less than 50 were observed was rated to be marginal, and a tape in which peels of 51 or more to 100 or less were observed was rated to be bad.

The first component (metal nanowires or metal nanotubes) used in the invention was prepared as described below.

### Synthesis of Silver Nanowires

A reaction mixture containing silver nanowires was obtained by putting 4.171 g of poly(N-vinylpyrrolidone) (trade name. Polyvinylpyrrolidone K30, MW 40,000, Tokyo Kasei Kogyo Co., Ltd.), 70 mg of tetrabutylammonium chloride (trade name: Tetrabutylammonium chloride, Wako Pure Chemical Industries, Ltd.), 4.254 g of silver nitrate (trade name: Silver nitrate, Wako Pure Chemical Industries, Ltd.) and 500 mL of ethylene glycol (trade name: Ethylene glycol, Wako Pure Chemical Industries, Ltd.) in a 1,000 mL flask, agitating the mixture for 15 minutes and uniformly dissolving the mixture, and agitating the mixture at 110° C. for 16 hours in an oil bath.

Subsequently, the reaction mixture was returned to room temperature (25 to 30° C.), and then a reaction solvent was replaced to water with a centrifuge (As One Corporation). Thus, aqueous silver nanowire dispersion solution I having an arbitrary concentration was obtained. According to the operation, unreacted silver nitrate, poly(N-vinylpyrrolidone) and tetrabutylammonium chloride used for controlling their morphology, ethylene glycol and silver nanoparticles having a small particle size in the reaction mixture were removed. A silver nanowire dispersion aqueous solution having an arbitrary concentration was obtained by redispersing precipitates on a filter paper into water. Mean values of length the silver nanowires in a minor axis, length thereof in a major axis and an aspect ratio thereof (n=10) were 42 nanometers, 18 micrometers and 429, respectively.

A binder solution being the second component (polysaccharides and the derivative thereof) used in the invention was prepared as described below.

### Preparation of a Binder Solution

In a 300 mL beaker whose tare weight was premeasured, 100 g of ultrapure water was put, and heated and agitated. At a liquid temperature of 80 to 90° C., 2.00 g of hydroxypropyl methyl cellulose (abbreviated as HPMC, trade name: Metolose 90SH-100000, Shin-Etsu Chemical Co., Ltd., 100,000 mPa·s in viscosity of a 2 wt. % aqueous solution) was put in the beaker little by little, and agitated strongly to disperse HPMC uniformly. While keeping strong agitation, 80 g of ultrapure water was added, simultaneously heating was stopped, and agitation was continued while cooling the beaker with ice water until a uniform solution was formed. After agitation for 20 minutes, ultrapure water was added to be 200.00 g in a weight of the aqueous solution, agitation was continued for further 10 minutes at room temperature until a uniform solution was formed, and thus 1 wt. % aqueous binder solution was prepared.

### Preparation of a Base Solution

A silver nanowire dispersion aqueous solution and a 1.0 wt. % binder solution were mixed, and a base solution containing 0.25 wt. % silver nanowires and 0.5 wt. % HPMC was prepared using ultrapure water.

### Example 1

### Preparation of Polymer Solution I (Third Component) (Containing Polyvinyl Alcohol Having an Acetoacetyl Group)

Then, 0.08 g of Gohsefimer Z-200 (trade name) (polyvinyl alcohol having an acetoacetyl group, the Nippon Synthetic Chemical Industry Co., Ltd.) was weighed, and diluted with 7.92 g of ultrapure water to prepare 1.0 wt. % polymer aqueous solution I.

### Preparation of Crosslinking Agent Solution I (Fourth Component)

Then, 0.11 g of Nikalac MW-22 (trade name) (having N-methylol ether group, Sanwa Chemical Co., Ltd.) having a solid component concentration of 70% by weight was weighed, and diluted with 7.89 g of isopropyl alcohol (IPA) to prepare 1.0 wt. % crosslinking agent aqueous solution I.

### Preparation of a Surfactant Solution

Then, 0.08 g of TritonX-100 (trade name) (octylphenylpolyethyleneglycol, Sigma-Aldrich Japan K.K.) was weighed, and diluted with 7.92 g of ultrapure water to prepare a 1.0 wt. % surfactant solution.

### Preparation of a Coating Forming Composition

Then, 4.80 g of the base solution, 0.20 g of the surfactant solution, 1.44 g of ultrapure water and 1.20 g of polymer solution I were weighed, and stirred until a uniform solution was formed. Subsequently, 0.36 g of crosslinking solution I having a solid content of 1.0% by weight was added, and the resultant mixture was agitated until a uniform solution was formed. Thus, a coating forming composition having a composition as described below was obtained. The prepared coating forming composition had a viscosity of 31.5 mPa·s, and showed a good dispersibility.

| | |
|---|---|
| Silver nanowires | 0.15% by weight |
| HPMC | 0.3% by weight |
| Gohsefimer Z-200 | 0.15% by weight |
| Nikalac MW-22 | 0.045% by weight |
| Triton X-100 | 0.025% by weight |
| IPA | 4.5% by weight |
| Water | 94.830% by weight |

In addition, HPMC corresponded to 200 parts by weight based on 100 parts by weight of silver nanowires, Gohsefimer Z-200 corresponded to 100 parts by weight based on 100 parts by weight of silver nanowires, and Nikalac corresponded to 10 parts by weight based on 100 parts by weight of the total weight of HPMC and Gohsefimer Z-200.

### Preparation of a Transparent Conductive Film

On a surface of a 0.7 mm-thick Eagle XG (trade name) (Corning, Inc.) glass substrate subjected to UV ozone treatment with irradiation at an irradiation energy of 1,000 mJ/cm² (low pressure mercury lamp (254 nanometers)), 1 mL of the resultant coating forming composition was dropped, and spin coating was performed at 700 rpm using a spin coater (trade name: MS-A150, Mikasa Co., Ltd.). Pre-bake was performed on the glass substrate on a hot stage at 50° C. under conditions for 90 seconds, and then post-bake was performed for 3 minutes on a hot stage at 140° C. Thus, a transparent conductive film was prepared.

### Evaluation of the Transparent Conductive Film

The resultant transparent conductive film had a surface resistance value of 42.4Ω/□, a total transmittance of 92.0%, a haze of 1.3% and a film thickness of 52 nanometers. Moreover, environmental reliability, suitability for process and adhesion were favorable. Furthermore, the environmental reliability, the suitability for process and the adhesion were favorable also on silicon nitride and an overcoat (product name: PIG-7414, JNC Corporation).

The evaluation results are shown in Table 1. In addition, only an evaluation using the glass substrate was summarized in the table.

### Example 2

### Preparation of Polymer Solution II (Third Component) (Containing Polyvinyl Alcohol Having an Acetoacetyl Group)

Then, 0.08 g of Gohsefimer Z-300 (trade name) (polyvinyl alcohol having an acetoacetyl group, the Nippon Synthetic Chemical Industry Co., Ltd) was weighed, and diluted with 7.92 g of ultrapure water to prepare 1.0 wt. % polymer aqueous solution II.

### Preparation of a Coating Forming Composition

Then, 4.80 g of the base solution, 0.20 g of the surfactant solution, 1.44 g of ultrapure water and 1.20 g of polymer solution II were weighed, and stirred until a uniform solution was formed. Subsequently, 0.36 g of crosslinking agent solution I having a solid content of 1.0% by weight was added, and the resultant mixture was stirred until a uniform solution was formed. Thus, a coating forming composition having a composition as described below was obtained. The prepared coating forming composition had a viscosity of 31.6 mPa·s, and showed a good dispersibility.

| | |
|---|---|
| Silver nanowires | 0.15% by weight |
| HPMC | 0.3% by weight |
| Gohsefimer Z-300 | 0.15% by weight |
| Nikalac MW-22 | 0.045% by weight |
| Triton X-100 | 0.025% by weight |
| IPA | 4.5% by weight |
| Water | 94.830% by weight |

In addition, HPMC corresponded to 200 parts by weight based on 100 parts by weight of silver nanowires, Gohsefimer Z-300 corresponded to 100 parts by weight based on 100 parts by weight of silver nanowires, and Nikalac corresponded to 10 parts by weight based on 100 parts by weight of the total weight of HPMC and Gohsefimer Z-300.

A transparent conductive film was prepared according to procedures similar to Example 1. The resultant transparent conductive film had a surface resistance value of 42.0Ω/□, a total transmittance of 92.0%, a haze of 1.4% and a film thickness of 51 nanometers. Moreover, environmental reliability, suitability for process and adhesion were favorable. Furthermore, the environmental reliability, the suitability for process and the adhesion were favorable also on silicon nitride and an overcoat (product name: PIG-7414, JNC Corporation).

### Example 3

### Preparation of Polymer Solution III (Third Component) (Containing Polyvinyl Alcohol Having an Acetoacetyl Group)

Then, 0.08 g of Gohsefimer Z-410 (trade name) (polyvinyl alcohol having an acetoacetyl group, the Nippon Synthetic Chemical Industry Co., Ltd.) was weighed, and diluted with 7.92 g of ultrapure water to prepare 1.0 wt. % polymer aqueous solution III.

### Preparation of a Coating Forming Composition

Then, 4.80 g of the base solution, 0.20 g of the surfactant solution, 1.44 g of ultrapure water and 1.20 g of polymer solution III were weighed, and stirred until a uniform solution was formed. Subsequently, 0.36 g of crosslinking agent solution I having a solid content of 1.0% by weight was added, and the resultant mixture was stirred until a uniform solution was formed. Thus, a coating forming composition having a composition as described below was obtained. The prepared coating forming composition had a viscosity of 31.0 mPa·s, and showed a good dispersibility.

| | |
|---|---|
| Silver nanowires | 0.15% by weight |
| HPMC | 0.3% by weight |
| Gohsefimer Z-410 | 0.15% by weight |
| Nikalac MW-22 | 0.045% by weight |
| Triton X-100 | 0.025% by weight |
| IPA | 4.5% by weight |
| Water | 94.830% by weight |

In addition, HPMC corresponded to 200 parts by weight based on 100 parts by weight of silver nanowires, Gohsefimer Z-410 corresponded to 100 parts by weight based on 100 parts by weight of silver nanowires, and Nikalac corresponded to 10 parts by weight based on 100 parts by weight of the total weight of HPMC and Gohsefimer Z-410.

A transparent conductive film was prepared according to procedures similar to Example 1. The resultant transparent conductive film had a surface resistance value of 42.8Ω/□, a total transmittance of 92.0%, a haze of 1.5% and a film thickness of 52 nanometers. Moreover, environmental reliability, suitability for process and adhesion were favorable. Furthermore, the environmental reliability, the suitability for process and the adhesion were favorable also on silicon nitride and an overcoat (product name: PIG-7414, INC Corporation).

### Example 4

### Polymerization of Acrylic Polymer Solution IV (Third Component) Having an Acetoacetyl Group (as a Composition Using an Acrylic Polymer Having the Acetoacetyl Group)

Then, 0.10 g of ethylene glycol monoacetoacetate monomethacrylate (trade name) (methacrylate having an acetoacetyl group, Tokyo Kasei Kogyo Co., Ltd.), 0.20 g of FA-513M (trade name) (methacrylate having a tricyclododecane side chain, Hitachi Chemical Co., Ltd.), 0.60 g of hydroxyethyl acrylate (trade name) (Kanto Kagaku Industry), 0.10 g of acrylic acid (trade name) (Kanto Kagaku Industry), and 0.03 g of V-086 (trade name) (2,2′-azobis[2-methyl-N-(2-hydroxyethyl)propioamide], Wako Pure Chemical Industries, Ltd.) were dissolved in 2.0 g of ultrapure water, and the resultant mixture was stirred for 4 hours at 80° C. under a nitrogen atmosphere. Transparent and viscous acrylic polymer solution IV having an acetoacetyl group was obtained.

### Preparation of Polymer Solution IV (Third Component)

Then, 0.24 g of acrylic polymer solution IV having the acetoacetyl group was weighed, and diluted with 7.76 g of ultrapure water to prepare 1.0 wt. % polymer aqueous solution IV

### Preparation of a Coating Forming Composition

Then, 4.80 g of the base solution, 0.20 g of the surfactant solution, 1.44 g of ultrapure water and 1.20 g of polymer solution IV were weighed, and stirred until a uniform solution was formed. Subsequently, 0.36 g of crosslinking agent solution I having a solid content of 1.0% by weight was added, and the resultant mixture was stirred until a uniform solution was formed. Thus, a coating forming composition having a composition as described below was obtained. The prepared coating forming composition had a viscosity of 31.6 mPa·s, and showed a good dispersibility.

| | |
|---|---|
| Silver nanowires | 0.15% by weight |
| HPMC | 0.3% by weight |
| Acrylic polymer IV having | 0.15% by weight |
| an acetoacetyl group | |
| Nikalac MW-22 | 0.045% by weight |
| Triton X-100 | 0.025% by weight |
| IPA | 4.5% by weight |
| Water | 94.830% by weight |

In addition, HPMC corresponded to 200 parts by weight based on 100 parts by weight of silver nanowires, acrylic polymer IV having an acetoacetyl group corresponded to 100 parts by weight based on 100 parts by weight of silver nanowires, and Nikalac corresponded to 10 parts by weight based on 100 parts by weight of the total weight of HPMC and acrylic polymer IV having an acetoacetyl group.

A transparent conductive film was prepared according to procedures similar to Example 1. The resultant transparent conductive film had a surface resistance value of 56.8Ω/□, a total transmittance of 91.0%, a haze of 2.5% and a film thickness of 50 nanometers. Moreover, environmental reliability, suitability for process and adhesion were favorable. Furthermore, the environmental reliability, the suitability for process and the adhesion were favorable also on silicon nitride and an overcoat (product name: PIG-7414, INC Corporation).

### Example 5

### Preparation of Catalyst I (Additive Component) (as a Composition Containing Polyvinyl Alcohol Having an Acetoacetyl Group and a Protected Methylol Compound)

Then, 0.20 g of NACURE 3525 (trade name) (sulfonate catalyst, King Industries, Inc.) was weighed, and diluted with 49.8 g of ultrapure water to prepare 0.1 wt % catalyst aqueous solution I.

### Preparation of a Coating Forming Composition

Then, 4.80 g of the base solution, 0.20 g of the surfactant solution, 0.72 g of ultrapure water and 1.20 g of polymer solution I were weighed, and stirred until a uniform solution was formed. Subsequently, 0.36 g of crosslinking agent solution I having a solid content of 1.0% by weight and 0.72 g of catalyst aqueous solution I having a solid content of 0.1% by weight were added, and the resultant mixture was stirred until a uniform solution was formed. Thus, a coating forming composition having a composition as described below was obtained. The prepared coating forming composition had a viscosity of 31.8 mPa·s, and showed a good dispersibility.

| | |
|---|---|
| Silver nanowires | 0.15% by weight |
| HPMC | 0.3% by weight |
| Gohsefimer Z-200 | 0.15% by weight |
| Nikalac MW-22 | 0.045% by weight |
| Triton X-100 | 0.025% by weight |
| NACURE 3525 | 0.0090% by weight |
| IPA | 4.5% by weight |
| Water | 94.8210% by weight |

In addition, HPMC corresponded to 200 parts by weight based on 100 parts by weight of silver nanowires, Gohsefimer Z-200 corresponded to 100 parts by weight based on 100 parts by weight of silver nanowires, and Nikalac corresponded to 10 parts by weight based on 100 parts by weight of the total weight of HPMC and Gohsefimer Z-200.

A transparent conductive film was prepared according to procedures similar to Example 1. The resultant transparent conductive film had a surface resistance value of 40.1 DID, a total transmittance of 92.2%, a haze of 1.3% and a film thickness of 50 nanometers. Moreover, environmental reliability, suitability for process and adhesion were favorable. Furthermore, the environmental reliability, the suitability for process and the adhesion were favorable also on silicon nitride and an overcoat (product name: PIG-7414, JNC Corporation).

### Example 6

### Composition Containing Polyvinyl Alcohol and a Methylol Compound Having an Acetoacetyl Group

### Preparation of Crosslinking Agent Solution II (Fourth Component)

Then, 0.10 g of Riken Resin MM-35 (trade name) (methylol melamine compound, Miki Riken Industry) having a solid component concentration of 80% by weight was weighed, and diluted with 7.90 g of ultrapure water to prepare 1.0 wt. % crosslinking agent solution II.

### Preparation of Catalyst II (Additive Component)

Then, 22.9 mg of Riken Fixer RC-3 (trade name) (catalyst, Miki Riken Industry) having a solid component concentration of 35% by weight was weighed, and diluted with 7.98 g of ultrapure water to prepare 0.1 wt. % catalyst aqueous solution II.

### Preparation of a Coating Forming Composition

Then, 4.80 g of the base solution, 0.20 g of the surfactant solution, 1.08 g of ultrapure water and 1.20 g of polymer solution I were weighed, and stirred until a uniform solution was formed. Subsequently, 0.36 g of crosslinking agent solution II having a solid content of 1.0% by weight and 0.036 g of catalyst aqueous solution II having a solid content of 0.1% by weight were added, and the resultant mixture was stirred until a uniform solution was formed. Thus, a coating forming composition having a composition as described below was obtained. The prepared coating forming composition had a viscosity of 31.5 mPa·s, and showed a good dispersibility.

| | | |
|---|---|---|
| Silver nanowires | 0.15% | by weight |
| HPMC | 0.3% | by weight |
| Gohsefimer Z-200 | 0.15% | by weight |
| Riken Resin MM-35 | 0.045% | by weight |
| Triton X-100 | 0.025% | by weight |
| Riken Fixer RC-3 | 0.0045% | by weight |
| Water | 99.3255% | by weight |

In addition, HPMC corresponded to 200 parts by weight based on 100 parts by weight of silver nanowires, Gohsefimer Z-200 corresponded to 100 parts by weight based on 100 parts by weight of silver nanowires, and Riken Resin corresponded to 10 parts by weight based on 100 parts by weight of the total weight of HPMC and Gohsefimer Z-200.

A transparent conductive film was prepared according to procedures similar to Example 1. The resultant transparent conductive film had a surface resistance value of 41.1Ω/□, a total transmittance of 91.8%, a haze of 1.4% and a film thickness of 53 nanometers. Moreover, environmental reliability, suitability for process and adhesion were favorable. Furthermore, the environmental reliability, the suitability for process and the adhesion were favorable also on silicon nitride and an overcoat (product name: PIG-7414, JNC Corporation).

### Example 7

### Composition Containing Polyvinyl Alcohol Having an Acetoacetyl Group and an Amine Compound

### Preparation of Crosslinking Agent Solution III (Fourth Component)

Then, 0.10 g of hexamethylenediamine dihydrochloride (trade name) (Wako Pure Chemical Industries, Ltd.) was weighed, and diluted with 9.90 g of ultrapure water to prepare 1.0 wt. % crosslinking agent solution III.

### Preparation of a Coating Forming Composition

Then, 4.80 g of the base solution, 0.20 g of the surfactant solution, 1.44 g of ultrapure water and 1.20 g of polymer solution I were weighed, and stirred until a uniform solution was formed. Subsequently, 0.36 g of crosslinking agent solution III having a solid content of 1.0% by weight was added, and the resultant mixture was stirred until a uniform solution was formed. Thus, a coating forming composition having a composition as described below was obtained. The prepared coating forming composition had a viscosity of 31.5 mPa·s, and showed a good dispersibility.

| | | |
|---|---|---|
| Silver nanowires | 0.15% | by weight |
| HPMC | 0.3% | by weight |
| Gohsefimer Z-200 | 0.15% | by weight |
| Hexamethylenediamine | 0.045% | by weight |
| dihydrochloride | | |
| Triton X-100 | 0.025% | by weight |
| Water | 99.330% | by weight |

In addition, HPMC corresponded to 200 parts by weight based on 100 parts by weight of silver nanowires, Gohsefimer Z-200 corresponded to 100 parts by weight based on 100 parts by weight of silver nanowires, and hexamethylenediamine dihydrochloride corresponded to 10 parts by weight based on 100 parts by weight of the total weight of HPMC and Gohsefimer Z-200.

A transparent conductive film was prepared according to procedures similar to Example 1. The resultant transparent conductive film had a surface resistance value of 50.2Ω/□, a total transmittance of 90.5%, a haze of 1.8% and a film thickness of 53 nanometers. Moreover, environmental reliability, suitability for process and adhesion were favorable. Furthermore, the environmental reliability, the suitability for process and the adhesion were favorable also on silicon nitride and an overcoat (product name: PIG-7414, JNC Corporation).

### Example 8

### Composition Containing Polyvinyl Alcohol Having an Acetoacetyl Group and an Aldehyde Compound

### Preparation of Crosslinking Agent Solution IV (Fourth Component)

Then, 0.10 g of glyoxal (trade name) (Wako Pure Chemical Industries, Ltd.) was weighed, and diluted with 9.90 g of ultrapure water to prepare 1.0 wt. % crosslinking agent solution IV.

### Preparation of a Coating Forming Composition

Then, 4.80 g of the base solution, 0.20 g of the surfactant solution, 1.44 g of ultrapure water and 1.20 g of polymer solution I were weighed, and stirred until a uniform solution was formed.

Subsequently, 0.36 g of crosslinking agent solution IV having a solid content of 1.0% by weight was added, and the resultant mixture was stirred until a uniform solution was formed. Thus, a coating forming composition having a composition as described below was obtained. The prepared coating forming composition had a viscosity of 31.2 mPa·s, and showed a good dispersibility.

| | | |
|---|---|---|
| Silver nanowires | 0.15% | by weight |
| HPMC | 0.3% | by weight |
| Gohsefimer Z-200 | 0.15% | by weight |
| Glyoxal | 0.045% | by weight |
| Triton X-100 | 0.025% | by weight |
| Water | 99.330% | by weight |

In addition, HPMC corresponded to 200 parts by weight based on 100 parts by weight of silver nanowires, Gohsefimer Z-200 corresponded to 100 parts by weight based on 100 parts by weight of silver nanowires, and glyoxal corresponded to 10 parts by weight based on 100 parts by weight of the total weight of HPMC and Gohsefimer Z-200.

A transparent conductive film was prepared according to procedures similar to Example 1. The resultant transparent conductive film had a surface resistance value of 48.2Ω/□, a total transmittance of 91.6%, a haze of 1.4% and a film thickness of 52 nanometers. Moreover, environmental reliability, suitability for process and adhesion were favorable. Furthermore, the environmental reliability, the suitability for process and the adhesion were favorable also on silicon nitride and an overcoat (product name: PIG-7414, JNC Corporation).

### Example 9

### Composition Containing Polyvinyl Alcohol Having an Acetoacetyl Group and an Aldehyde Compound

### Preparation of Crosslinking Agent Solution V (Fourth Component)

Then, 0.10 g of Sequarez 755 (trade name) (glyoxal-crosslinked starch, Omnova Solutions Inc.) was weighed, and diluted with 9.90 g of ultrapure water to prepare 1.0 wt. % crosslinking agent solution V.

### Preparation of a Coating Forming Composition

Then, 4.80 g of the base solution, 0.20 g of the surfactant solution, 1.44 g of ultrapure water and 1.20 g of polymer solution I were weighed, and stirred until a uniform solution was formed. Subsequently, 0.36 g of crosslinking agent solution V having a solid content of 1.0% by weight was added, and the resultant mixture was stirred until a uniform solution was formed. Thus, a coating forming composition having a composition as described below was obtained. The prepared coating forming composition had a viscosity of 33.0 mPa·s, and showed a good dispersibility.

| | | |
|---|---|---|
| Silver nanowires | 0.15% | by weight |
| HPMC | 0.3% | by weight |
| Gohsefimer Z-200 | 0.15% | by weight |
| Glyoxal-crosslinked | 0.045% | by weight |
| starch | | |
| Triton X-100 | 0.025% | by weight |
| Water | 99.330% | by weight |

In addition, HPMC corresponded to 200 parts by weight based on 100 parts by weight of silver nanowires, Gohsefimer Z-200 corresponded to 100 parts by weight based on 100 parts by weight of silver nanowires, and glyoxal-crosslinked starch corresponded to 10 parts by weight based on 100 parts by weight of the total weight of HPMC and Gohsefimer Z-200.

A transparent conductive film was prepared according to procedures similar to Example 1. The resultant transparent conductive film had a surface resistance value of 47.0Ω/□, a total transmittance of 91.5%, a haze of 1.4% and a film thickness of 52 nanometers. Moreover, environmental reliability, suitability for process and adhesion were favorable. Furthermore, the environmental reliability, the suitability for process and the adhesion were favorable also on silicon nitride and an overcoat (product name: PIG-7414, JNC Corporation).

### Example 10

### Preparation of a Coating Forming Composition (as a Composition Containing Polyvinyl Alcohol Having an Acetoacetyl Group in which an Amount of Third Component Addition is Lower, as Compared with the Composition in Example 1)

Then, 4.80 g of the base solution, 0.20 g of the surfactant solution, 2.68 g of ultrapure water and 0.08 g of polymer solution I were weighed, and stirred until a uniform solution was formed. Subsequently, 0.24 g of crosslinking agent solution I having a solid content of 1.0% by weight was added, and the resultant mixture was stirred until a uniform solution was formed. Thus, a coating forming composition having a composition as described below was obtained. The prepared coating forming composition had a viscosity of 31.8 mPa·s, and showed a good dispersibility.

| | | |
|---|---|---|
| Silver nanowires | 0.15% | by weight |
| HPMC | 0.3% | by weight |
| Gohsefimer Z-200 | 0.01% | by weight |
| Nikalac MW-22 | 0.03% | by weight |
| Triton X-100 | 0.025% | by weight |
| IPA | 3.0% | by weight |
| Water | 96.485% | by weight |

In addition, HPMC corresponded to 200 parts by weight based on 100 parts by weight of silver nanowires, Gohsefimer Z-200 corresponded to 6.67 parts by weight based on 100 parts by weight of silver nanowires, and Nikalac corresponded to 18.75 parts by weight based on 100 parts by weight of the total weight of HPMC and Gohsefimer Z-200.

A transparent conductive film was prepared according to procedures similar to Example 1. The resultant transparent conductive film had a surface resistance value of 42.8Ω/□, a total transmittance of 92.2%, a haze of 1.2% and a film thickness of 49 nanometers. Moreover, environmental reliability, suitability for process and adhesion were favorable. Furthermore, the environmental reliability, the suitability for process and the adhesion were favorable also on silicon nitride and an overcoat (product name: PIG-7414, JNC Corporation).

### Example 11

### Preparation of a Coating Forming Composition (as a Composition Containing Polyvinyl Alcohol Having an Acetoacetyl Group in which an Amount of Third Component Addition is Lower, as Compared with the Composition in Example 1)

Then, 4.80 g of the base solution, 0.20 g of the surfactant solution, 0.36 g of ultrapure water and 2.40 g of polymer solution I were weighed, and stirred until a uniform solution was formed. Subsequently, 0.24 g of crosslinking agent solution I having a solid content of 1.0% by weight was added, and the resultant mixture was stirred until a uniform solution was formed. Thus, a coating forming composition having a composition as described below was obtained. The prepared coating forming composition had a viscosity of 31.8 mPa·s, and showed a good dispersibility.

| | | |
|---|---|---|
| Silver nanowires | 0.15% | by weight |
| HPMC | 0.3% | by weight |
| Gohsefimer Z-200 | 0.3% | by weight |
| Nikalac MW-22 | 0.03% | by weight |
| Triton X-100 | 0.025% | by weight |
| IPA | 3.0% | by weight |
| Water | 96.195% | by weight |

In addition, HPMC corresponded to 200 parts by weight based on 100 parts by weight of silver nanowires, Gohsefimer Z-200 corresponded to 200 parts by weight based on 100 parts by weight of silver nanowires, and Nikalac corresponded to 5 parts by weight based on 100 parts by weight of the total weight of HPMC and Gohsefimer Z-200.

A transparent conductive film was prepared according to procedures similar to Example 1. The resultant transparent conductive film had a surface resistance value of 47.0Ω/□, a total transmittance of 92.1%, a haze of 1.7% and a film thickness of 70 nanometers. Moreover, environmental reliability, suitability for process and adhesion were favorable. Furthermore, the environmental reliability, the suitability for process and the adhesion were favorable also on silicon nitride and an overcoat (product name: PIG-7414, JNC Corporation).

### Example 12

### Preparation of a Coating Forming Composition (as a Composition Containing Polyvinyl Alcohol Having an Acetoacetyl Group in which an Amount of Fourth Component Addition is Lower, as Compared with the Composition in Example 1

Then, 4.80 g of the base solution, 0.20 g of the surfactant solution, 0.36 g of ultrapure water and 2.40 g of polymer solution I were weighed, and stirred until a uniform solution was formed. Subsequently, 0.24 g of crosslinking agent solution I having a solid content of 1.0% by weight was added, and the resultant mixture was stirred until a uniform solution was formed. Thus, a coating forming composition having a composition as described below was obtained. The prepared coating forming composition had a viscosity of 31.8 mPa·s, and showed a good dispersibility.

| | | |
|---|---|---|
| Silver nanowires | 0.15% | by weight |
| HPMC | 0.3% | by weight |
| Gohsefimer Z-200 | 0.15% | by weight |
| Nikalac MW-22 | 0.09% | by weight |
| Triton X-100 | 0.025% | by weight |
| IPA | 9.0% | by weight |
| Water | 90.285% | by weight |

In addition, HPMC corresponded to 200 parts by weight based on 100 parts by weight of silver nanowires, Gohsefimer Z-200 corresponded to 100 parts by weight based on 100 parts by weight of silver nanowires, and Nikalac corresponded to 20 parts by weight based on 100 parts by weight of the total weight of HPMC and Gohsefimer Z-200.

A transparent conductive film was prepared according to procedures similar to Example 1. The resultant transparent conductive film had a surface resistance value of 42.8Ω/□, a total transmittance of 92.0%, a haze of 1.4% and a film thickness of 70 nanometers. Moreover, environmental reliability, suitability for process and adhesion were favorable. Furthermore, the environmental reliability, the suitability for process and the adhesion were favorable also on silicon nitride and an overcoat (product name: PIG-7414, JNC Corporation).

### Example 13

### Preparation of a Coating Forming Composition (as a Composition Containing Polyvinyl Alcohol Having an Acetoacetyl Group and Two Kinds of Fourth Components (a Protected Methylol Compound and an Amine Compound))

Then, 4.80 g of the base solution, 0.20 g of the surfactant solution, 0.36 g of ultrapure water and 1.20 g of polymer solution I were weighed, and stirred until a uniform solution was formed. Subsequently, 0.36 g of crosslinking agent solution I having a solid content of 1.0% by weight was added, and the resultant mixture was stirred until a uniform solution was formed. Thus, a coating forming composition having a composition as described below was obtained. The prepared coating forming composition had a viscosity of 32.5 mPa·s, and showed a good dispersibility.

| | | |
|---|---|---|
| Silver nanowires | 0.15% | by weight |
| HPMC | 0.3% | by weight |
| Gohsefimer Z-200 | 0.15% | by weight |
| Nikalac MW-22 | 0.045% | by weight |
| Hexamethylenediamine | 0.135% | by weight |
| dihydrochloride | | |
| Triton X-100 | 0.025% | by weight |
| IPA | 4.5% | by weight |
| Water | 94.695% | by weight |

In addition, HPMC corresponded to 200 parts by weight based on 100 parts by weight of silver nanowires, Gohsefimer Z-200 corresponded to 100 parts by weight based on 100 parts by weight of silver nanowires, and the total weight of Nikalac and hexamethylenediamine dihydrochloride corresponded to 40 parts by weight based on 100 parts by weight of the total weight of HPMC and Gohsefimer Z-200.

A transparent conductive film was prepared according to procedures similar to Example 1. The resultant transparent conductive film had a surface resistance value of 46.5Ω/□, a total transmittance of 92.0%, a haze of 1.5% and a film thickness of 60 nanometers. Moreover, environmental reliability, suitability for process and adhesion were favorable. Furthermore, the environmental reliability, the suitability for process and the adhesion were favorable also on silicon nitride and an overcoat (product name: PIG-7414, INC Corporation).

### Example 14

### Composition Containing Polyvinyl Alcohol Having an Acetoacetyl Group, and an Epoxy Compound

### Preparation of Crosslinking Agent Solution VI (Fourth Component)

Then, 0.264 g of Sumirez 633 (trade name) (compound having an epoxy group, Taoka Chemical Co., Ltd.) having a solid component concentration of 30% by weight was weighed, and diluted with 7.75 g of ultrapure water to prepare 1.0 wt. % crosslinking agent solution VI.

### Preparation of a Coating Forming Composition

Then, 4.80 g of the base solution, 0.20 g of the surfactant solution, 1.44 g of ultrapure water and 0.36 g of polymer solution I were weighed, and stirred until a uniform solution was formed. Subsequently, 0.24 g of crosslinking agent solution VI having a solid content of 1.0% by weight was added, and the resultant mixture was stirred until a uniform solution was formed. Thus, a coating forming composition having a composition as described below was obtained. The prepared coating forming composition had a viscosity of 32.8 mPa·s, and showed a good dispersibility.

| | | |
|---|---|---|
| Silver nanowires | 0.15% | by weight |
| HPMC | 0.3% | by weight |
| Gohsefimer Z-200 | 0.15% | by weight |
| Sumirez 633 | 0.045% | by weight |
| Triton X-100 | 0.025% | by weight |
| Water | 99.33% | by weight |

In addition, HPMC corresponded to 200 parts by weight based on 100 parts by weight of silver nanowires, Gohsefimer Z-200 corresponded to 100 parts by weight based on 100 parts by weight of silver nanowires, and Sumirez 633 corresponded to 10 parts by weight based on 100 parts by weight of the total weight of HPMC and Gohsefimer Z-200.

A transparent conductive film was prepared according to procedures similar to Example 1. The resultant transparent conductive film had a surface resistance value of 46.0Ω/□, a total transmittance of 91.8%, a haze of 1.5% and a film thickness of 58 nanometers. Moreover, environmental reliability, suitability for process and adhesion were favorable. Furthermore, the environmental reliability, the suitability for process and the adhesion were favorable also on silicon nitride and an overcoat (product name: PIG-7414, JNC Corporation).

### Example 15

### Composition Containing Polyvinyl Alcohol Having an Acetoacetyl Group, and an Isocyanate Compound

### Preparation of Crosslinking Agent Solution VII (Fourth Component)

Then, 1.16 g of Elastoron BN-11 (trade name) (compound having an isocyanate group, Dai-Ichi Kogyo Seiyaku Co., Ltd.) having a solid component concentration of 34.5% by weight was weighed, and diluted with 6.84 g of ultrapure water to prepare 1.0 wt. % crosslinking agent solution VII.

### Preparation of a Coating Forming Composition

Then, 4.80 g of the base solution, 0.20 g of the surfactant solution, 1.44 g of ultrapure water and 0.36 g of polymer solution I were weighed, and stirred until a uniform solution was formed. Subsequently, 0.24 g of crosslinking agent solution VII having a solid content of 1.0% by weight was added, and the resultant mixture was stirred until a uniform solution was formed. Thus, a coating forming composition having a composition as described below was obtained. The prepared coating forming composition had a viscosity of 33.2 mPa·s, and showed a good dispersibility.

| | | |
|---|---|---|
| Silver nanowires | 0.15% | by weight |
| HPMC | 0.3% | by weight |
| Gohsefimer Z-200 | 0.15% | by weight |
| Elastoron BN-11 | 0.045% | by weight |
| Triton X-100 | 0.025% | by weight |
| Water | 99.33% | by weight |

In addition, HPMC corresponded to 200 parts by weight based on 100 parts by weight of silver nanowires, Gohsefimer Z-200 corresponded to 100 parts by weight based on 100 parts by weight of silver nanowires, and Elastoron BN-11 corresponded to 10 parts by weight based on 100 parts by weight of the total weight of HPMC and Gohsefimer Z-200.

A transparent conductive film was prepared according to procedures similar to Example 1. The resultant transparent conductive film had a surface resistance value of 52.6Ω/□, a total transmittance of 91.0%, a haze of 1.5% and a film thickness of 60 nanometers. Moreover, environmental reliability, suitability for process and adhesion were favorable. Furthermore, the environmental reliability, the suitability for process and the adhesion were favorable also on silicon nitride and an overcoat (product name: PIG-7414, JNC Corporation).

### Comparative Example 1

### Preparation of Polymer Solution IV (that is not a Third Component) (in which a Compound Having No 1,3-Dicarbonyl Group was Used)

Then, 0.08 g of polyvinyl alcohol (trade name) (a degree of polymerization of 1,500 and a degree of saponification of 96%, Wako Pure Chemical Industries, Ltd.) was weighed, and diluted with 7.92 g of ultrapure water to prepare 1.0 wt. % polymer aqueous solution I.

### Preparation of a Coating Forming Composition

Then, 4.80 g of the base solution, 0.20 g of the surfactant solution, 1.44 g of ultrapure water and 1.20 g of polymer solution IV were weighed, and stirred until a uniform solution was formed. Subsequently, 0.36 g of crosslinking agent solution I having a solid content of 1.0% by weight was added, and the resultant mixture was stirred until a uniform solution was formed. Thus, a coating forming composition having a composition as described below was obtained. The prepared coating forming composition had a viscosity of 31.5 mPa·s, and showed a good dispersibility.

| | | |
|---|---|---|
| Silver nanowires | 0.15% | by weight |
| HPMC | 0.3% | by weight |
| Polyvinyl alcohol | 0.15% | by weight |
| Nikalac MW-22 | 0.045% | by weight |
| Triton X-100 | 0.025% | by weight |
| IPA | 4.5% | by weight |
| Water | 94.830% | by weight |

In addition, HPMC corresponded to 200 parts by weight based on 100 parts by weight of silver nanowires, polyvinyl alcohol corresponded to 100 parts by weight based on 100 parts by weight of silver nanowires, and Nikalac corresponded to 10 parts by weight based on 100 parts by weight of the total weight of HPMC and polyvinyl alcohol.

A transparent conductive film was prepared according to procedures similar to Example 1. The resultant transparent conductive film had a surface resistance value of 42.1Ω/□, a total transmittance of 92.1%, a haze of 1.4% and a film thickness of 50 nanometers. Moreover, environmental reliability, suitability for process and adhesion were poor.

### Comparative Example 2

### Preparation of a Coating Forming Composition (as a Composition in which No Third Component was Added)

Then, 4.80 g of the base solution, 0.20 g of the surfactant solution and 2.64 g of ultrapure water were weighed, and stirred until a uniform solution was formed. Subsequently, 0.36 g of crosslinking agent solution I having a solid content of 1.0% by weight was added, and the resultant mixture was stirred until a uniform solution was formed. Thus, a coating forming composition having a composition as described below was obtained. The prepared coating forming composition had a viscosity of 31.6 mPa·s, and showed a good dispersibility.

| | | |
|---|---|---|
| Silver nanowires | 0.15% | by weight |
| HPMC | 0.3% | by weight |
| Nikalac MW-22 | 0.03% | by weight |
| Triton X-100 | 0.025% | by weight |
| IPA | 3.0% | by weight |
| Water | 96.495% | by weight |

In addition, HPMC corresponded to 200 parts by weight based on 100 parts by weight of silver nanowires, and Nikalac corresponded to 10 parts by weight based on 100 parts by weight of HPMC.

A transparent conductive film was prepared according to procedures similar to Example 1. The resultant transparent conductive film had a surface resistance value of 40.5Ω/□, a total transmittance of 92.0%, a haze of 1.1% and a film thickness of 51 nanometers. Moreover, environmental reliability, suitability for process and adhesion were poor.

### Comparative Example 3

### Composition in which Neither a Third Component Nor a Fourth Component was Added

A composition for forming a transparent conductive film and the transparent conductive film used in Comparative Example 3 were appropriately prepared based on the description in Example 17 described in JP 2010-507199 A as described below.

### Preparation of a Coating Forming Composition

Then, 4.80 g of the base solution, 0.20 g of the surfactant solution and 3.00 g of ultrapure water were weighed, and stirred until a uniform solution was formed. Thus, a coating forming composition having a composition as described below was obtained. The prepared coating forming composition had a viscosity of 31.5 mPa·s, and showed a good dispersibility.

| | | |
|---|---|---|
| Silver nanowires | 6 0.15% | by weight |
| HPMC | 0.3% | by weight |
| Triton X-100 | 0.025% | by weight |
| Water | 99.525% | by weight |

In addition, HPMC corresponded to 200 parts by weight based on 100 parts by weight of silver nanowires.

A transparent conductive film was prepared according to procedures similar to Example 1. The resultant transparent conductive film had a surface resistance value of 38.5Ω/□, a total transmittance of 92.2%, a haze of 1.0% and a film thickness of 53 nanometers. Moreover, environmental reliability, suitability for process and adhesion were poor.

### Comparative Example 4

### Preparation of a Coating Forming Composition (as a Composition in which No Fourth Component was Added)

Then, 4.80 g of the base solution, 0.20 g of the surfactant solution, 1.44 g of ultrapure water and 1.20 g of polymer solution I were weighed, and stirred until a uniform solution was formed. Thus, a coating forming composition having a composition as described below was obtained. The prepared coating forming composition had a viscosity of 31.4 mPa·s, and showed a good dispersibility.

| | | |
|---|---|---|
| Silver nanowires | 0.15% | by weight |
| HPMC | 0.3% | by weight |
| Gohsefimer Z-200 | 0.15% | by weight |
| Triton X-100 | 0.025% | by weight |
| IPA | 4.5% | by weight |
| Water | 94.875% | by weight |

In addition, HPMC corresponded to 200 parts by weight based on 100 parts by weight of silver nanowires, and Gohsefimer Z-200 corresponded to 100 parts by weight based on 100 parts by weight of silver nanowires.

A transparent conductive film was prepared according to procedures similar to Example 1. The resultant transparent conductive film had a surface resistance value of 40.0Ω/□, a total transmittance of 92.0%, a haze of 1.1% and a film thickness of 52 nanometers. Moreover, environmental reliability, suitability for process and adhesion were poor.

TABLE 1

| | | Transparency | | | |
|---|---|---|---|---|---|
| | Conductivity | Total | | | |
| | Surface resistance | transmittance | Haze | Environmental | Suitability |
| Sample name | (Ω/□) | (%) | (%) | reliability | for process |
| Example 1 | 42.4 | 92.0 | 1.3 | Excellent | Excellent |
| Example 2 | 42.0 | 92.0 | 1.4 | Excellent | Excellent |
| Example 3 | 42.8 | 92.0 | 1.5 | Excellent | Excellent |
| Example 4 | 56.8 | 91.0 | 2.0 | Excellent | Excellent |
| Example 5 | 40.1 | 92.2 | 1.3 | Excellent | Excellent |
| Example 6 | 41.1 | 91.8 | 1.4 | Excellent | Excellent |
| Example 7 | 50.2 | 90.5 | 1.8 | Good | Good |
| Example 8 | 48.2 | 91.6 | 1.4 | Good | Good |
| Example 9 | 47.0 | 91.5 | 1.4 | Excellent | Good |
| Example 10 | 42.8 | 92.2 | 1.2 | Good | Good |
| Example 11 | 47.0 | 92.1 | 1.7 | Excellent | Excellent |
| Example 12 | 42.8 | 92.0 | 1.4 | Excellent | Excellent |
| Example 13 | 46.5 | 92.0 | 1.5 | Excellent | Excellent |
| Example 14 | 46.0 | 91.8 | 1.5 | Good | Good |
| Example 15 | 52.6 | 91.0 | 1.5 | Good | Good |
| Comparative | 42.1 | 92.1 | 1.4 | Marginal | Bad |
| Example 1 | | | | | |
| Comparative | 40.5 | 92.0 | 1.1 | Marginal | Marginal |
| Example 2 | | | | | |
| Comparative | 38.5 | 92.2 | 1.0 | Bad | Bad |
| Example 3 | | | | | |
| Comparative | 40.0 | 91.0 | 1.1 | Marginal | Bad |
| Example 4 | | | | | |

Although the invention has been described and illustrated with a certain degree of particularity, it is understood that the disclosure has been made only by way of example, and that numerous changes in the conditions and order of steps can be resorted to by those skilled in the art without departing from the spirit and scope of the invention.

### INDUSTRIAL APPLICABILITY

A coating forming composition for a transparent conductive film according to the invention can be used in a process for manufacturing a device element such as a liquid crystal display element, an organic electroluminescence display, an electronic paper, a touch panel element and a photovoltaic cell element.

What is claimed is:

1. A coating forming composition, comprising:
at least one kind selected from the group of metal nanowires and metal nanotubes as a first component;
at least one kind selected from the group of polysaccharides and a derivative thereof as a second component;
an active methylene compound as a third component;
an electrophilic compound as a fourth component; and
a solvent as a fifth component.

2. The coating forming composition according to claim 1, wherein the electrophilic compound as the fourth component is at least one kind selected from the group of an isocyanate compound, an epoxy compound, an aldehyde compound, an amine compound and a methylol compound.

3. The coating forming composition according to claim 1, wherein the active methylene compound as the third component is a compound having a 1,3-dicarbonyl group.

4. The coating forming composition according to claim 1, wherein the first component is silver nanowires.

5. The coating forming composition according to claim 1, wherein the second component is a cellulose ether derivative.

6. The coating forming composition according to claim 1, wherein the third component is polyvinyl alcohol having an acetoacetyl group.

7. The coating forming composition according to claim 1, wherein the electrophilic compound as the fourth component comprises a methylol compound.

8. The coating forming composition according to claim 1, wherein the second component is hydroxypropyl methyl cellulose.

9. The coating forming composition according to claim 1, wherein a content of the first component is in the range of 0.01% by weight to 1.0% by weight, a content of the second component is in the range of 0.005% by weight to 3.0% by weight, a content of the third component is in the range of 0.0005% by weight to 3.0% by weight, a content of the fourth components is in the range of 0.000055% by weight to 6.0% by weight, and a content of the solvent is in the range of 87.0% by weight to 99.98% by weight, based on the total weight of the coating forming composition.

10. The coating forming composition according to claim 1, used for forming a conductive coating.

11. A substrate having a transparent conductive film obtained using the coating forming composition according to claim 10, wherein a thickness of the transparent conductive film is in the range of 10 nanometers to 150 nanometers, a surface resistance of the transparent conductive film is in the range of 10Ω/□ to 5,000Ω/□, and a total transmittance of the transparent conductive film is in the range of 85% or more.

12. A device element, using the substrate according to claim 11.
